(19) United States
(12) Patent Application Publication
(10) Pub. No.: US 2026/0264554 A1
(43) Pub. Date: Sep. 10, 2026

(54) SYSTEMATIC SOLUTION FOR OPTIMIZED CHARGING

(71) Applicant: Volvo Car Corporation, Göteborg (SE)

(72) Inventors: Xuming YAO, Göteborg (SE); Chih Feng LEE, Västra Frölunda (SE); Andreas KARLSSON, Torslanda (SE); Magnus BERGLUND, Göteborg (SE); Peter STAGE, Göteborg (SE); Anette WESTERLUND, Mölndal (SE); Henrik BJERSING, Västra Frölunda (SE); Deepak Arul PRAKASH, Göteborg (SE); Carl LEVIN, Göteborg (SE); Nayana JOY, Mölndal (SE)

(73) Assignee: Volvo Car Corporation, Göteborg (SE)

(21) Appl. No.: 19/069,468

(22) Filed: Mar. 4, 2025

(51) Int. Cl. B60L 53/62; B60L 53/63; B60L 53/65; B60L 53/66; B60L 53/68

(52) U.S. Cl. CPC B60L 53/62; B60L 53/63; B60L 53/65; B60L 53/66; B60L 53/68; B60L 2240/545; B60L 2240/547; B60L 2240/549; B60L 2240/662; B60L 2240/80; B60L 2260/58

(57) ABSTRACT

A system is described herein. The system comprises a processor and a non-transitory memory. The processor stores instructions in the non-transitory memory that, when executed, causes the processor to: receive one or more inputs related to a charging schedule; determine one or more factors that influence the charging schedule in accordance with the one or more inputs, a charging cost, one or more battery parameters, one or more grid parameters, one or more usage patterns, and one or more external conditions; predict real-time information corresponding to the one or more factors; compute the charging schedule in accordance with the real-time information to charge one or more battery packs of a vehicle to the target battery level within the departure time of the vehicle; and communicate the charging schedule to at least one of an on-board charger of the vehicle and an Electric Vehicle Supply Equipment (EVSE).

### FIELD OF THE DISCLOSURE

The present disclosure relates generally to charging management systems. More specifically, the present disclosure relates to a systematic solution for computing an optimized charging schedule to charge an electric vehicle to a target battery level by the departure time.

### BACKGROUND

The advancement of electric vehicles (EVs) has brought a significant focus on optimizing the battery charging process to improve energy efficiency, reduce charging costs, and enhance user convenience. In traditional charging systems, the charging schedules are often static, lacking the flexibility to adapt to dynamic variables such as real-time energy availability, electricity pricing, and vehicle usage patterns. This inflexibility can lead to inefficient energy utilization, increased costs, and suboptimal charging outcomes for EV users.

Recent developments in smart charging technologies aim to address these challenges by leveraging real-time data to compute dynamic charging schedules. For example, information about electricity pricing, grid load, charging station availability, and user-defined preferences, such as target battery levels, can be utilized to optimize the charging process. By integrating such real-time information, charging systems can ensure that the battery packs of a vehicle are charged to the desired level while aligning with the user's preference.

However, there remains a need for further advancements in computing charging schedules that can efficiently account for the interplay between real-time information and user-defined parameters, such as departure times. Current methods often lack the computational robustness to handle complex scenarios involving multiple battery packs, fluctuating real-time data, and varying user requirements. Addressing these limitations will enable more efficient and reliable charging solutions for electric vehicles, thereby supporting the broader adoption of EV technology.

Therefore, there is a long-felt need for a system and method for computing a charging schedule to charge an electric vehicle to a target battery level by the departure time.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

In one or more embodiments described herein, systems, devices, computer-implemented methods, methods, apparatus, and/or computer program products are presented that facilitate computing a charging schedule for charging an electric vehicle to a target battery level by the departure time.

In an aspect, a system is described. The system comprises a server. The server comprises a processor and a non-transitory memory. The processor storing instructions in the non-transitory memory that, when executed, causes the processor to: receive one or more inputs related to a charging schedule; determine one or more factors that influence the charging schedule in accordance with the one or more inputs, a charging cost, one or more battery parameters, one or more grid parameters, one or more usage patterns, and one or more external conditions; predict real-time information corresponding to the one or more factors; compute the charging schedule in accordance with the real-time information to charge one or more battery packs of a vehicle to the target battery level within the departure time of the vehicle; and communicate the charging schedule to at least one of an on-board charger of the vehicle and an Electric Vehicle Supply Equipment (EVSE). The one or more inputs comprises a departure time, a target battery level, and one or more user preferences. The one or more factors comprises at least one of a charging time, a charging duration, an itinerary, a charging cost, one or more battery parameters, one or more grid parameters, one or more usage patterns, and one or more external conditions.

In an aspect, a method is described. The method comprises: receiving, by a processor, one or more inputs related to a charging schedule; determining, by the processor, one or more factors that influence the charging schedule in accordance with the one or more inputs; predicting, by the processor, real-time information corresponding to the one or more factors; computing, by the processor, the charging schedule in accordance with the real-time information, the one or more battery parameters, the one or more usage patterns, and the one or more external conditions to charge one or more battery packs of a vehicle to the target battery level within the departure time of the vehicle; and communicating, by the processor, the charging schedule to at least one of an on-board charger of the vehicle and an Electric Vehicle Supply Equipment (EVSE). The one or more inputs comprises a departure time, a target battery level, and one or more user preferences. The one or more factors comprises at least one of a charging time, a charging duration, an itinerary, a charging cost, one or more battery parameters, one or more grid parameters, one or more usage patterns, and one or more external conditions.

In an aspect, a non-transitory computer-readable storage medium is described. The non-transitory computer-readable storage medium comprising a sequence of instructions, which when executed by a processor causes: receiving one or more inputs related to a charging schedule; determining one or more factors that influence the charging schedule in accordance with the one or more inputs; predicting real-time information corresponding to the one or more factors; computing the charging schedule in accordance with the real-time information, the one or more battery parameters, the one or more usage patterns, and the one or more external conditions to charge one or more battery packs of a vehicle to the target battery level within the departure time of the vehicle; and communicating the charging schedule to at least one of an on-board charger of the vehicle and an Electric Vehicle Supply Equipment (EVSE). The one or more inputs comprises a departure time, a target battery level, and one or more user preferences. The one or more factors comprises at least one of a charging time, a charging duration, an itinerary, a charging cost, one or more battery parameters, one or more grid parameters, one or more usage patterns, and one or more external conditions.

The methods and systems disclosed herein may be implemented in any means for achieving various aspects and may be executed in a form of a non-transitory machine-readable medium embodying a set of instructions that, when executed by a machine, causes the machine to perform any of the operations disclosed herein. Other features will be apparent from the accompanying drawings and from the detailed description that follows.

### BRIEF DESCRIPTION OF THE FIGURES

These and other aspects of the present disclosure will now be described in more detail, with reference to the appended drawings showing exemplary embodiments, in which:

FIG. 1 illustrates a system comprising a server in the cloud, according to one or more embodiments.

FIG. 2 illustrates a system comprising a server within a vehicle, according to one or more embodiments.

FIG. 3 illustrates a system comprising a server within an electric vehicle supply equipment (EVSE), according to one or more embodiments.

FIG. 4 illustrates a system, according to one or more embodiments.

FIG. 5 illustrates a method, according to one or more embodiments.

FIG. 6 illustrates a computer system comprising a non-transitory computer-readable storage medium, according to one or more embodiments.

FIG. 7 illustrates an overall configuration diagram of a system according to one or more embodiments.

FIG. 8 schematically shows a battery pack comprising a battery and a battery management system, according to one or more embodiments.

FIG. 9 illustrates an overall system architecture, according to one or more embodiments.

FIG. 10 illustrates a communication flow between a server, an electric vehicle (EV), and an electric vehicle supply equipment (EVSE), according to one or more embodiments.

FIG. 11 illustrates a charging schedule computed by the processor, according to one or more embodiments.

FIG. 12A shows a structure of the neural network/machine learning model with a feedback loop.

FIG. 12B shows a structure of the neural network/machine learning model with reinforcement learning.

Other features of the present embodiments will be apparent from the accompanying drawings and from the detailed description that follows.

### DETAILED DESCRIPTION

For simplicity and clarity of illustration, the figures illustrate the general manner of construction. The description and figures may omit the descriptions and details of well-known features and techniques to avoid unnecessarily obscuring the present disclosure. The figures exaggerate the dimensions of some of the elements relative to other elements to help improve understanding of embodiments of the present disclosure. The same reference numeral in different figures denotes the same element.

Although the detailed description herein contains many specifics for the purpose of illustration, a person of ordinary skill in the art will appreciate that many variations and alterations to the details are considered to be included herein. Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the subject matter herein. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include,” “have,” and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

As used herein, the terms “left,” “right,” “front,” “back,” “top,” “bottom,” “over,” “under” and the like in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

No element act, or instruction used herein is critical or essential unless explicitly described as such. Furthermore, the term “set” includes items (e.g., related items, unrelated items, a combination of related items and unrelated items, etc.) and may be interchangeable with “one or more.” Where only one item is intended, the term “one” or similar language is used. Also, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the terms “couple,” “coupled,” “couples,” “coupling,” and the like refer to connecting two or more elements mechanically, electrically, and/or otherwise. Two or more electrical elements may be electrically coupled together, but not mechanically or otherwise coupled together. Coupling may be for any length of time, e.g., permanent, or semi-permanent or only for an instant. “Electrical coupling” includes electrical coupling of all types. The absence of the word “removably,” “removable,” and the like, near the word “coupled” and the like does not mean that the coupling, etc., in question is or is not removable.

As used herein, the term “or” means an inclusive “or” rather than an exclusive “or.” That is, unless specified otherwise, or clear from context. “X employs A or B” means any of the natural inclusive permutations. That is, if X employs A; X employs B; or X employs both A and B, then “X employs A or B” is satisfied under any of the foregoing instances.

As used herein, the term “one of A, B, and C” shall be understood to mean “only A, only B, or only C,” and not a combination of A, B, and C.

As used herein, the term “one or more of A, B, and C” shall be understood to mean any one of A, B, or C, or any combination thereof, including multiple occurrences of each element. This includes, but is not limited to, the following configurations: only A, only B, only C, A and B, A and C, B and C, A, B, and C, as well as multiple instances of A, multiple instances of B, multiple instances of C, or any combination of multiple instances of A, B, and C.

As used herein, the term “at least one of A, B, and C” shall be understood to mean any one of A, B, or C, or any combination thereof, including multiple occurrences of each element. This includes, but is not limited to, the following configurations: only A, only B, only C, A and B, A and C, B and C, A, B, and C, as well as multiple instances of A, multiple instances of B, multiple instances of C, or any combination of multiple instances of A, B, and C.

As used herein, two or more elements or modules are “integral” or “integrated” if they operate functionally together. Two or more elements are “non-integral” if each element can operate functionally independently.

As used herein, the term “real-time” refers to operations conducted as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Digital electronic circuitry, or in computer software, firmware, or hardware, including the structures disclosed in this specification and their structural equivalents, or in combinations of one or more of them may realize the implementations and all of the functional operations described in this specification. Implementations may be as one or more computer program products, i.e., one or more modules of computer program instructions encoded on a computer-readable medium for execution by, or to control the operation of, data processing apparatus. The computer-readable medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of a digital computer. A processor will receive instructions and data from a read-only memory or a random access memory or both. Elements of a computer can include a processor for performing instructions and one or more memory devices for storing instructions and data. A computer will also include, or is operatively coupled to receive data, transfer data or both, to/from one or more mass storage devices for storing data, e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc., may embed a computer. Computer-readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD-ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship between the client and server arises by virtue of computer programs running on the respective computers and having a client-server relationship with each other.

Embodiments may comprise or utilize a special purpose or general purpose computer including computer hardware. Embodiments within the scope of the present disclosure may also include physical and other computer-readable media for carrying or storing computer-executable instructions and/or data structures. Such computer-readable media can be any media accessible by a general purpose or special purpose computer system. Computer-readable media that store computer-executable instructions are physical storage media. Computer-readable media that carry computer-executable instructions are transmission media. Thus, by way of example and not limitation, embodiments of the disclosure can comprise at least two distinct kinds of computer-readable media: physical computer-readable storage media and transmission computer-readable media.

Although the present embodiments described herein are with reference to specific example embodiments, it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer-readable storage media includes RAM, ROM, EEPROM, CD-ROM or other optical disk storage (such as Compact Discs (CDs), Digital Versatile Disks (DVDs), etc.), magnetic disk storage or other magnetic storage devices, solid-state disks or any other medium. They store desired program code in the form of computer-executable instructions or data structures which can be accessed by a general purpose or special purpose computer.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media can include a network and/or data links which carry desired program code in the form of computer-executable instructions or data structures. The scope of computer-readable media includes combinations of the above, that enable the transport of electronic data between computer systems and/or modules and/or other electronic devices. Further, upon reaching various computer system components, program code in the form of computer-executable instructions or data structures can be transferred automatically from transmission computer-readable media to physical computer-readable storage media (or vice versa). For example, computer-executable instructions or data structures received over a network or data link can be buffered in RAM within a Network Interface Module (NIC), and then eventually transferred to computer system RAM and/or to less volatile computer-readable physical storage media at a computer system. Thus, computer system components that also (or even primarily) utilize transmission media may include computer-readable physical storage media.

Computer-executable instructions comprise, for example, instructions and data which cause a general purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together into a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer-readable media such as computer memory may practice the methods. In particular, one or more processors execute computer-executable instructions, stored in the computer memory, to perform various functions such as the acts recited in the embodiments.

Those skilled in the art will appreciate that the disclosure may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, etc. Distributed system environments where local and remote computer systems, which are linked through a network, both perform tasks, may practice the disclosure. In a distributed system environment, program modules may be located in both local and remote memory storage devices. The networks are linked either by hardwired data links, wireless data links, or by a combination of hardwired and wireless data links.

The following terms and phrases, unless otherwise indicated, shall have the following meanings.

As used herein, the term “input” refers to any data, commands, or information that is provided to a system, application, or device to influence its behavior or functionality. The inputs may be provided by a user or an external device or a sensor. This input is typically entered through various interfaces, such as keyboards, touchscreens, voice commands, or sensors, and serves as the primary means by which users interact with the system.

As used herein, the term “factor” refers to variables, conditions, or parameters that affect the determination, adjustment, or optimization of a charging plan or a charging schedule for a battery or energy storage system of a vehicle. These factors are considered by the system or algorithm to ensure the charging process meets specific goals, such as efficiency, cost-effectiveness, or adherence to user-defined constraints. The factors include user-defined parameters, battery parameters, energy and pricing information, grid and infrastructure constraints, environmental conditions, and vehicle usage patterns. By analyzing and integrating these factors, a charging schedule can be computed that optimizes for energy efficiency, cost, and user convenience while minimizing strain on the power grid or other systems.

As used herein, the term “charging schedule” refers to a planned or dynamically computed timeline and strategy for charging a battery or energy storage system of the vehicle. The charging schedule outlines when and how much energy should be delivered to the battery to meet specific objectives, such as reaching a target charge level, minimizing costs, or optimizing efficiency, while considering various constraints and influencing factors. The charging schedule comprises components such as start time, end time, charging rate, energy allocation, constraints, etc. For example, a charging schedule might specify that charging should start at 10:00 PM, use a slow charging rate during off-peak hours, and complete by 6:00 AM to achieve a 100% battery charge before a morning commute.

As used herein, the term “charging time” refers to a time allotted for charging. The user may provide the charging time. The charging station or the charging system may also determine the charging time. The charging time may be split into charging time segments. Each charging time segment may correspond to a different charging level. Each charging time segment may also correspond to charging the different portions of the battery pack.

As used herein, the term “charging duration” refers to the amount of time required to charge a battery pack to a desired level from a depleted state to its desired capacity. In an embodiment, the desired capacity may be the capacity required to jumpstart the recipient. In an embodiment, the desired capacity may be the full capacity. The charging duration depends on several factors, including battery capacity (C), charging current (I), and C-rate.

As used herein, the term “itinerary” refers to a detailed schedule of activities and events planned for a trip or event. The itinerary information comprises travel details such as vehicle ID, departure and arrival locations, departure and arrival times, intermediary waiting location, waiting time (halt time), number of occupants, estimated charge consumption, etc.

As used herein, the term “charging cost” refers to the total monetary expense incurred to charge a battery or energy storage system, for an electric vehicle (EV). The charging cost is influenced by various factors, including electricity pricing, energy consumption, and any associated fees or tariffs. The charging cost can be money, CO2, renewable energy, etc. required for charging the battery packs of the vehicle. The charging cost includes not only money but also environmental and sustainability factors like renewable energy usage and CO2 emissions. If charging is done using solar, wind, or hydroelectric power, the reliance on fossil fuels is reduced, lowering the environmental cost. If charging is done from the fossil-fuel grid, electricity generation produces CO2 emissions. The optimal charging schedule may be generated in accordance with the charging cost having lower monetary cost and environmental cost (e.g., CO₂ impact, etc.).

As used herein, the term “battery parameters” refers to the set of measurable characteristics, properties, or variables that define the operational state, performance, and behavior of a battery. These parameters are essential for monitoring, managing, and optimizing the battery's usage, charging, and overall health.

As used herein, the term “grid parameters” refers to the set of measurable variables and characteristics that define the operational state, performance, and conditions of an electrical grid. These parameters are critical for monitoring, managing, and optimizing the generation, distribution, and consumption of electrical energy within the grid network. By considering the conditions and characteristics of the electrical grid, a charging schedule can be optimized to ensure efficiency, cost-effectiveness, grid stability, and user convenience. Grid parameters directly impact the efficiency, timing, and cost-effectiveness of a charging schedule. By continuously monitoring and adapting to the grid's conditions, EVs and charging systems can optimize their charging plans, contributing to more stable grid operations, cost savings for users, and better integration of renewable energy. Smart charging systems that adjust in real-time to grid parameters provide the flexibility necessary for balancing grid load and ensuring the most efficient charging process.

As used herein, the term “usage pattern” refers to the predictable and recurring behavior or trends in how and when an electric vehicle (EV) is charged, based on the vehicle owner's routine, driving habits, and energy needs. Usage pattern involves understanding the typical charging frequency, timing, duration, and the amount of energy required based on the vehicle's usage.

As used herein, the term “external condition” refers to any factor or circumstance outside a system or device that can affect its operation, performance, or behavior. The external conditions typically include environmental, operational, and situational factors that are outside the control of the user or the system but can influence how the system functions.

As used herein, the term “real-time information” refers to data or updates that are provided immediately or with minimal delay as events or conditions occur. This information is constantly updated and reflects the current state of a system, environment, or process, allowing for timely decision-making and actions based on the most recent data.

As used herein, the term “target battery level” refers to the desired or predetermined amount of charge or energy that a battery pack is set to achieve by the end of a charging session. This level is typically expressed as a percentage of the battery's total capacity and can be defined by the user or automatically determined based on various factors like driving needs, energy efficiency, or time constraints.

As used herein, the term “departure time” refers to the specific time at which an electric vehicle (EV) or another type of vehicle is scheduled or planned to begin its journey or use. Departure time influences the timing and scheduling of the vehicle's charging process to ensure that the battery is sufficiently charged by the time the vehicle needs to be used. Departure time is a critical factor in optimizing charging schedules for electric vehicles. It helps ensure that the vehicle is charged adequately without unnecessary delays or overcharging, while also optimizing charging efficiency based on real-time conditions like energy pricing, grid load, and the vehicle's current battery state. By aligning the charging process with the departure time, users can achieve a balance between having enough charge for their trip and minimizing charging costs. The departure time may be set manually by the user, or it could be automatically determined based on patterns, such as daily commute schedules or calendar events. Departure time may define a window of time within which the vehicle should be ready, influencing whether the vehicle charges immediately, in the background, or at a specific time closer to the departure. Departure time can be either fixed (e.g., the vehicle needs to be ready by 8:00 AM every weekday) or variable, depending on the user's needs or external factors like meeting schedules or travel plans. The system can use the departure time as a reference point to compute the optimal charging schedule. For example, the system may prioritize charging to ensure that the vehicle reaches the target battery level before the departure time, while considering factors such as current battery charge, grid conditions, and electricity prices.

As used herein, the term “state-of-charge (SoC)” refers to the level of charge of a battery pack relative to its capacity. The units of SoC are percentage points (0%=empty; 100%=full). An alternative form of the same measure is the depth-of-discharge (DoD), the inverse of SoC (100%=empty; 0%=full). SoC is normally used when discussing the current state of a battery in use, while DoD is most often seen when discussing the lifetime of the battery after repeated use.

As used herein, the term “state-of-health (SoH)” refers to a figure of merit of the condition of a battery pack, compared to its ideal conditions. The state-of-health (SoH) of a battery pack describes the difference between a battery pack being studied and a fresh battery pack and considers cell aging. The SoH is the ratio of the maximum battery charge to its rated capacity. The SoH is represented in percentage form.

As used herein, the term “on-board charger (OBC)” refers to a device or component within an electric vehicle (EV) that is responsible for converting incoming AC (alternating current) electricity from an external power source (such as a charging station or wall outlet) into DC (direct current) electricity to charge the vehicle's battery. The OBC manages the charging process by controlling the amount of power supplied to the battery, ensuring it is charged safely, efficiently, and in accordance with the battery's specifications. The on-board charger works in conjunction with the vehicle's battery management system (BMS) to determine the charging parameters, including charging rate and termination point, based on the battery's capacity, health, and temperature.

As used herein, the term “battery aging” refers to the gradual and irreversible degradation of a battery's performance, capacity, and efficiency over time due to chemical, physical, and operational factors. Battery aging impacts the battery's ability to store and deliver energy, ultimately reducing its lifespan and effectiveness.

As used herein, the term “battery degradation” refers to the gradual decline in a battery's performance, capacity, and efficiency over time due to physical, chemical, and operational factors. Degradation affects the battery's ability to store and deliver energy, resulting in reduced capacity, lower power output, and shorter lifespan.

As used herein, the term “routine charging start time” refers to the specific, regularly scheduled time at which the charging process for a battery pack of a vehicle is set to begin. This time is often predetermined based on user preferences, typical usage patterns, or external conditions like electricity pricing or grid load. Routine charging start time helps in automating the charging process, ensuring convenience and efficiency while optimizing costs and energy usage. Routine charging start time supports better integration with the energy grid, reduces environmental impact, and enhances the overall user experience by aligning the charging schedule with daily routines.

As used herein, the term “routine charging end time” refers to the specific, regularly scheduled time by which the charging process for a battery, such as in an electric vehicle (EV), is intended to be completed. Routine charging end time ensures that the battery reaches the desired charge level within a predefined time, aligning with the user's needs and operational requirements. The routine charging end time ensures that the battery is fully charged and ready for use when needed, improving convenience and reliability. It helps optimize the charging process by aligning it with user schedules and external factors such as energy costs and grid load, while also contributing to better energy management and operational efficiency in electric vehicle charging systems

As used herein, the term “routine charging duration” refers to the total amount of time allocated for a routine charging session to charge a battery from its current state-of-charge to the desired level. This duration is typically influenced by the charging rate, battery capacity, charging cost, and the difference between the initial and target charge levels. Routine charging duration helps users and systems plan the charging process efficiently, ensuring that the battery is charged adequately within the available time.

As used herein, the term “routine charging sequence” refers to a prearranged or systematically designed framework that outlines how a battery pack is charged regularly over a specific period to meet the user's needs efficiently and reliably. This sequence takes into account user preferences, battery parameters, and external factors like electricity pricing and grid conditions.

As used herein, the term “routine charging location” refers to a specific, regularly used place where a battery pack in an electric vehicle (EV) is charged as part of a recurring charging schedule. This location is often selected based on convenience, accessibility, and compatibility with the vehicle's charging requirements.

As used herein, the term “routine arrival time” refers to regularly scheduled or expected time at which a vehicle arrives at a specific location, such as home, workplace, or a charging station.

As used herein, the term “routine departure time” refers to the regularly scheduled or expected time at which a vehicle departs from a specific location, such as home, workplace, or a parking station.

As used herein, the term “battery temperature” refers to the thermal condition or degree of heat within a battery pack of an electric vehicle (EV) that affects its performance, efficiency, and lifespan. The temperature of the battery plays a critical role in the charging process, energy storage, and overall vehicle operation.

As used herein, the term “ambient temperature” refers to the temperature of the surrounding environment or air, which can significantly influence the performance of a battery pack in an electric vehicle (EV) as well as other components within the vehicle.

As used herein, the term “charging temperature” refers to the specific temperature range at which a battery, such as in an electric vehicle (EV), is charged. Charging temperature may refer to increase in battery temperature from its initial temperature during charging. The temperature of the battery during charging plays a critical role in determining the efficiency, speed, and safety of the charging process, as well as the long-term health and performance of the battery.

As used herein, the term “electric vehicle supply equipment (EVSE)” refers to the infrastructure or devices that provide electrical power to charge an electric vehicle (EV). EVSE includes all components required to deliver electricity safely and efficiently from the power source (such as the grid) to the vehicle's on-board charging system. EVSE includes the charging cable, connector, safety mechanisms, communication protocols, and power management systems. EVSE ensures safe electricity transfer from the grid to the vehicle.

As used herein, the term “charging station” refers to the physical location or setup where EVSE is installed. A charging station may include one or multiple EVSE units, supporting different charging levels (Level 1, Level 2, or DC fast charging). A charging station is the place where one or more EVSE units are available for use, whereas EVSE is the technical equipment that enables charging. In simple terms, an EVSE is a part of a charging station, but a charging station may include multiple EVSE units.

As used herein, the term “peak demand hours” refers to the time periods when electricity consumption is at its highest. These hours typically occur when most people are actively using electricity. Peak demand varies by region, season, and lifestyle patterns. Peak demand puts stress on the electricity grid, potentially leading to higher energy prices, the need for backup power plants, and increased greenhouse gas emissions.

As used herein, the term “off-peak hours” refers to the periods when electricity demand is lower, typically outside the peak demand hours. During these times, electricity usage is less intense, leading to reduced strain on the grid and often lower electricity rates for consumers who are on time-of-use pricing plans.

As used herein, the term “grid frequency” refers to the rate at which alternating current (AC) electricity oscillates in a power grid, typically measured in Hertz (Hz). It is a critical parameter that indicates the balance between electricity supply and demand in the grid.

As used herein, the term “grid voltage” refers to the electrical potential difference provided by a power grid at specific points in the transmission or distribution network. Grid voltage is a critical parameter in the design and operation of electrical grids and determines how efficiently electricity is transmitted from generation sources to end-users.

As used herein, the term “load balancing” refers to the process of ensuring that electricity supply matches demand in real-time. It involves the strategic management of power generation, distribution, and consumption to maintain grid stability, prevent overloading, and optimize efficiency.

As used herein, the term “CO2 emission” refers to the amount of carbon dioxide (CO₂) emitted per unit of electricity consumed during the charging of an electric vehicle (EV) or other devices. It is typically measured in grams of CO2 per kilowatt-hour (gCO_{2/}kWh) and varies depending on the energy-mix and efficiency of the power grid.

As used herein, the term “trickle charging” refers to charging a battery pack continuously or periodically with a very small current. The trickle charge also refers to a continuous, slow charge applied to the battery pack.

As used herein, the term “fast charging” refers to charging a battery pack faster than regular charging.

As used herein, the term “regular charging” refers to charging a battery pack by supplying a standard charging voltage employed according to the capacity of the battery pack.

As used herein, the term “personal digital assistant” refers to a software-based virtual assistant that helps users manage tasks, organize information, and provide assistance in various activities through voice commands, text input, or other interactions. These assistants are designed to improve productivity and streamline daily activities, leveraging artificial intelligence (AI) and machine learning to personalize user experiences. The personal digital assistant may be a standalone device.

As used herein, the term “sleep mode” refers to a low-power state where non-essential systems are temporarily deactivated to conserve energy while maintaining the ability to quickly resume full operation.

As used herein, the term “calendar battery ageing” refers to the degradation process of a battery over time, even if it is not actively in use. The calendar battery ageing is a measure of how a battery's capacity and performance deteriorate as a function of its age, independent of charge and discharge cycles.

As used herein, the term “thermal system” refers to the network of components designed to manage the temperature within the vehicle, ensuring that both the engine and the passenger cabin are kept within optimal temperature ranges for comfort, efficiency, and performance. The thermal system also plays a critical role in managing heat from the battery in electric vehicles (EVs) to prevent overheating and optimize longevity.

As used herein, the term “thermal strategy” refers to a plan designed to manage and optimize the temperature within a vehicle to ensure its efficient operation, longevity, and safety. The thermal strategy involves managing the temperature of key components like the engine, battery, and cabin to optimize performance, energy efficiency, and battery life.

As used herein, the term “auxiliary load consumption” refers to the energy consumed by non-essential systems and components of a vehicle, which are necessary for its operation but are not part of the primary driving or core functions. These loads can include systems that operate even when the vehicle is not moving, such as air conditioning, infotainment systems, lighting, and power steering, among others.

As used herein, the term “nominal capacity” refers to the amount of electric charge a battery can store and deliver under normal operating conditions.

As used herein, the term “depth-of-discharge” refers to the percentage of a battery's total capacity that has been used or discharged relative to its nominal (full) capacity. It is a key metric in evaluating the health and lifespan of a battery. Essentially, DoD indicates how much of the battery's available energy has been depleted during a discharge cycle.

As used herein, the term “energy capacity” refers to the total amount of electrical energy the battery can store and provide for use by the vehicle's motor and other auxiliary loads, etc. The energy capacity is typically measured in kilowatt-hours (kWh).

As used herein, the term “nominal voltage” refers to the standard or average voltage at which a battery pack is designed to operate. The nominal voltage represents the typical voltage output under normal, non-peak conditions when the battery pack is neither fully charged nor fully discharged. Nominal voltage is a useful reference for understanding the expected voltage behavior of the battery pack or system during its typical usage.

As used herein, the term “open circuit voltage” refers to the voltage of a battery pack when it is not connected to any load or circuit—that is, when no current is flowing through the battery. Open circuit voltage is essentially the voltage measured across the terminals of the battery in an idle state, with no external power draw or charge applied.

As used herein, the term “cutoff voltage” refers to the minimum or maximum voltage threshold at which a battery or a battery-powered device is designed to stop discharging or charging to protect the battery from damage or excessive wear.

As used herein, the term “charge voltage” refers to the voltage applied to a battery during the charging process. Charge voltage is the potential difference between the battery's positive and negative terminals when it is being charged. The charge voltage is typically higher than the nominal voltage of the battery and it is necessary to drive current into the battery to increase its state-of-charge.

As used herein, the term “charge per distance” refers to the amount of energy (in terms of battery charge) required to travel a specific distance in an electric vehicle (EV) or any battery-powered vehicle. Charge per distance is often used to evaluate the efficiency of a vehicle's energy consumption, typically measured in kilowatt-hours per kilometer (kWh/km) or kilowatt-hours per mile (kWh/mi or kWh/100 mi). This metric helps assess how much energy the vehicle uses to travel a given distance and can be used to estimate how far the vehicle can travel on a given amount of charge.

As used herein, the term “capacity rate (C-rate)” refers to a measure used to describe the charging or discharging speed of a battery in relation to its capacity. Capacity rate (C-rate) defines how quickly a battery can be charged or discharged relative to its nominal capacity.

As used herein, the term “internal resistance” refers to the opposition to the flow of electric current within a battery or other energy storage device. Internal resistance is caused by the materials and components inside the battery that resist the movement of charge (electrons and ions) during both charging and discharging processes.

As used herein, the term “cycle life” refers to the number of complete charge and discharge cycles a battery pack can undergo before its capacity drops to a certain percentage of its original capacity. In other words, the term “cycle life” indicates how many times a battery can be charged and discharged (fully or partially) before it reaches the end of its usable life.

As used herein, the term “Operating Temperature Range” refers to the range of temperatures within which a battery pack can function effectively without causing damage, performance degradation, or safety risks. This range specifies the minimum and maximum temperatures at which a battery pack can be safely charged, discharged, or used.

As used herein, the term “storage temperature range” refers to the range of temperatures within which a battery pack can be stored without causing damage, performance degradation, or safety issues. Unlike the operating temperature range, which pertains to temperatures during use, the storage temperature range specifically addresses conditions when the battery pack is not in use.

As used herein, the term “thermal runaway threshold” refers to the point at which a battery pack undergoes an uncontrollable increase in temperature, leading to a self-sustaining process that can cause severe damage, including fire, explosion, or other hazardous outcomes. This phenomenon typically occurs when a battery's internal temperature rises beyond a certain threshold, triggering a series of exothermic reactions that accelerate the temperature increase.

As used herein, the term “overcharge protection limit” refers to the maximum voltage or charge level at which a battery can safely be charged without causing damage, degradation, or triggering safety hazards such as thermal runaway. Overcharging occurs when a battery is charged beyond its rated voltage or capacity, leading to potential internal chemical reactions that can compromise its performance, safety, and lifespan.

As used herein, the term “over discharge protection limit” refers to the minimum voltage level or state-of-charge (SOC) below which a battery should not be discharged to avoid damaging its internal structure, reducing its capacity, or triggering safety risks. Discharging a battery beyond this limit can result in irreversible damage, such as degradation of the battery's electrolyte, capacity loss, or internal short circuits, which could compromise its performance and safety.

As used herein, the term “form factor” refers to the physical shape, size, and configuration of the battery. The form factor defines how the battery is designed to fit into specific devices or systems. The form factor influences not only the battery's compatibility with the device but also its energy density, efficiency, and performance.

As used herein, the term “charging current” refers to the amount of electrical current (measured in amperes, or A) supplied to a battery during the charging process. This current flows into the battery from the power source (such as a charger or power supply) and is responsible for replenishing the battery's stored energy.

As used herein, the term “battery pack” refers to a set of any number of identical batteries or individual cells of a battery in a vehicle. The “battery pack” may also refer to a set of non-identical batteries. The configuration of batteries in the battery pack may be in series, parallel or a combination of both to deliver the desired voltage, capacity, and/or power density.

As used herein, the term “Battery Management System (BMS)” refers to an electronic system designed to monitor and manage the performance, safety, and reliability of a rechargeable battery. The BMS ensures that the battery operates within its optimal parameters, thereby maximizing its lifespan and efficiency. The term “battery management system (BMS)” also refers to a system that is used to monitor and control power storage systems, assure health of battery cells, and deliver power to vehicle systems.

As used herein, the term “electric vehicle (EV)” refers to an automobile, as defined in 49 Code of Federal Regulations (CFR) 523.3, intended for highway use, powered by an electric motor that draws current from an on-vehicle energy storage device, such as a battery, which is rechargeable from an off-vehicle source, such as residential or public electric service or an on-vehicle fuel powered generator. The EV may be two or more wheeled vehicles manufactured for use primarily on public streets and roads. The EV may be referred to as an electric car, an electric automobile, an electric road vehicle (ERV), a plug-in vehicle (PV), a plug-in vehicle (xEV), etc., and the xEV may be classified into a plug-in all-electric vehicle, a battery-electric vehicle (BEV), a plug-in electric vehicle (PEV), a hybrid electric vehicle (HEV), a hybrid plug-in electric vehicle (HPEV), a plug-in hybrid electric vehicle (PHEV), etc.

As used herein, the term “plug-in electric vehicle (PEV)” refers to an Electric Vehicle that recharges the on-vehicle primary battery by connecting to the power grid.

As used herein, the term “plug-in vehicle (PV)” refers to an electric vehicle rechargeable through wireless charging from an electric vehicle supply equipment (EVSE) without using a physical plug or a physical socket.

As used herein, the term “heavy duty vehicle (HD Vehicle)” refers to any four or more wheeled vehicle as defined in 49 CFR 523.6 or 49 CFR 37.3 (bus).

As used herein, the term “light duty plug-in electric vehicle” refers to a three or four wheeled vehicle propelled by an electric motor drawing current from a rechargeable storage battery or other energy devices for use primarily on public streets, roads and highways and rated at less than 4,545 kg (10,000 lbs.) gross vehicle weight.

As used herein, the term “module” refers to any hardware, software, firmware, electronic control component, processing logic, and/or processor device, individually or in any combination, including without limitation: application specific integrated circuit (ASIC), a field programmable gate array (FPGA), an electronic circuit, a processor (shared, dedicated, or group) and memory that executes one or more software or firmware programs, a combinational logic circuit, and/or other suitable components that provide the described functionality.

As used herein, the term “vehicle computer system” refers to an embedded system in automotive electronics that controls one or more of the electrical systems or subsystems in a vehicle. The computer executes a large number of different software functions in the powertrain, chassis, driver assistance, and infotainment domains, etc., that are executed on separate control units. The vehicle computer system may be communicatively coupled with an external device of a user. The vehicle computer system may also be communicatively coupled with the charging station.

As used herein, the term “level 1 charging” refers to a charge that uses 120-207 Volts. Every electric vehicle or plug-in hybrid can be charged on level 1 charging by plugging the charging equipment into a regular wall outlet. Level 1 charging may be the slowest way to charge an EV. Level 1 charging generally adds between 3 and 5 miles of range per charging hour.

As used herein, the term “level 2 charging” refers to a charge that uses 208-240 Volts. Level 2 charging is most commonly used for daily EV charging. Level 2 charging equipment can be installed at home, at the workplace, as well as in public locations like shopping plazas, train stations and other destinations. Level 2 charging can replenish between 12 and 80 miles of range per charging hour, depending on the power output of the Level 2 charger, and the vehicle's maximum charge voltage.

As used herein, the term “level 3 charging” refers to a charge that uses 400-900 Volts DC. Level 3 charging is the fastest type of charging available and can recharge the EV at a rate of 3 to 20 miles of range per charging minute. Unlike Level 1 charging and Level 2 charging that uses alternating current (AC), Level 3 charging uses direct current (DC).

As used herein, the term “communication” refers to the transmission of information and/or data from one point to another. Communication may be by means of electromagnetic waves. It is also a flow of information from one point, known as the source, to another, the receiver (recipient). Communication comprises one of the following: transmitting data, instructions, and information or a combination of data, instructions, and information. Communication happens between any two communication systems or communicating units. The term “in communication with” may refer to any coupling, connection, or interaction using electrical signals to exchange information or data, using any system, hardware, software, protocol, or format, regardless of whether the exchange occurs wirelessly or over a wired connection. The term “communication” includes systems that combine other more specific types of communication, such as V2I (Vehicle-to-Infrastructure), V2N (Vehicle-to-Network), V2V (Vehicle-to-Vehicle), V2P (Vehicle-to-Pedestrian), V2D (Vehicle-to-Device) and V2G (Vehicle-to-Grid) and Vehicle-to-Everything (V2X) communication. V2X communication is the transmission of information from a vehicle to any entity that may affect the vehicle, and vice versa. The main motivations for developing V2X are occupant safety, road safety, traffic efficiency and energy efficiency. Depending on the underlying technology employed, there are two types of V2X communication technologies: cellular networks and other technologies that support direct device-to-device communication (such as Dedicated Short-Range Communication (DSRC), Port Community System (PCS), Bluetooth®, Wi-Fi®, etc.). Further, the emergency communication apparatus is configured on a computer with the communication function and is connected for bidirectional communication with the on-vehicle emergency report apparatus by a communication line through a radio station and a communication network such as a public telephone network or by satellite communication through a communication satellite. The emergency communication apparatus is adapted to communicate, through the communication network, with communication terminals including a road management office, a police station, a fire department, and a hospital. The emergency communication apparatus can also be connected online with the communication terminals of the persons or vehicles concerned, associated with the occupant or vehicle, and the driver or vehicle receiving the service of the emergency-reporting vehicle.

As used herein, the term “communication system” or “communication module” as used herein refers to a system which enables the information exchange between two points. The process of transmission and reception of information is called communication. The major elements of communication include but are not limited to a transmitter of information, channel or medium of communication and a receiver of information.

As used herein, the term “Dashboard” is a type of interface that visualizes particular Key Performance Indicators (KPIs) for a specific goal or process. It is based on data visualization and infographics.

As used herein, the term “command” refers to instructions given to perform a specific function. The command may specify a particular operation such as performing arithmetic calculations, moving data between memory locations, branching to a different part of the program, or interacting with input/output devices. Commands are encoded in binary format and are represented by a sequence of bits that the appropriate module interprets and executes. The module fetches instructions and decodes them to determine the operation to perform, and then executes them accordingly.

As used herein, a “Database” is a collection of organized information so that it can be easily accessed, managed, and updated. Computer databases typically contain aggregations of data records or files.

As used herein, the term “deviation” refers to difference from an established standard, norm, or expected value. Deviations are often quantifiable and measurable, allowing for analysis and comparison. Deviations provide insights into trends, anomalies, or patterns that may require attention or further investigation.

As used herein, the term “electric drive unit” refers to a unit that can control the operation of various devices of the vehicle (e.g., autonomous vehicle, manual driven vehicle, semi-autonomous vehicle, etc.). The electric drive unit is responsible for enabling the mobility of the vehicle. The electric drive unit refers to a system that integrates electric motors, power electronics, and control mechanisms to propel or assist in the propulsion of the vehicle.

As used herein, a “Sensor” is a device that detects and measures physical properties from the surrounding environment and converts this information into electrical or digital signals that can be interpreted by either a human or a machine for further processing. Sensors play a crucial role in collecting data for various applications across industries. Sensors may be made of electronic, mechanical, chemical, or other engineering components. Most sensors are electronic (the data is converted into electronic data), but some are simpler, such as a glass thermometer, which presents visual data. Examples include sensors to measure temperature, pressure, humidity, proximity, light, acceleration, orientation, etc. In an embodiment, sensors may be removably or fixedly installed within the vehicle and may be disposed in various arrangements to provide information to the autonomous operation features.

The term “vehicle” as used herein refers to a thing used for transporting people or goods. Automobiles, cars, trucks, buses, etc., are examples of vehicles.

The terms “non-transitory computer-readable medium” and “computer-readable medium” include a single medium or multiple media such as a centralized or distributed database, and/or associated caches and servers that store one or more sets of instructions. Further, the terms “non-transitory computer-readable medium” and “computer-readable medium” include any tangible medium that is capable of storing, encoding, or carrying a set of instructions for execution by a processor that, for example, when executed, cause a system to perform any one or more of the methods or operations disclosed herein. As used herein, the term “computer-readable medium” is expressly defined to include any type of computer-readable storage device and/or storage disk and to exclude propagating signals.

The term “in communication with” as used herein, refers to any coupling, connection, or interaction using electrical signals to exchange information or data, using any system, hardware, software, protocol, or format, regardless of whether the exchange occurs wirelessly or over a wired connection.

As used herein, the term “network” may include the Internet, a local area network, a wide area network, or combinations thereof. The network may include one or more networks or communication systems, such as the Internet, the telephone system, satellite networks, cable television networks, and various other private and public networks. In addition, the connections may include wired connections (such as wires, cables, fiber optic lines, etc.), wireless connections, or combinations thereof. Furthermore, although not shown, other computers, systems, devices, and networks may also be connected to the network. Network refers to any set of devices or subsystems connected by links joining (directly or indirectly) a set of terminal nodes sharing resources located on or provided by network nodes. The computers use common communication protocols over digital interconnections to communicate with each other. For example, subsystems may comprise the cloud. Cloud refers to servers that are accessed over the Internet, and the software and databases that run on those servers.

The term “autonomous vehicle” also referred to as self-driving vehicle, driverless vehicle, robotic vehicle as used herein refers to a vehicle incorporating vehicular automation, that is, a ground vehicle that can sense its environment and move safely with little or no human input. Self-driving vehicles combine a variety of sensors to perceive their surroundings, such as thermographic cameras, Radio Detection and Ranging (radar), Light Detection and Ranging (lidar), Sound Navigation and Ranging (sonar), Global Positioning System (GPS), odometry and inertial measurement unit. Control systems, designed for the purpose, interpret sensor information to identify appropriate navigation paths, as well as obstacles and relevant signage.

As used herein, the term “semi-autonomous vehicle” refers to vehicles that can operate for extended periods with little human input. A semi-autonomous vehicle cannot drive itself at all times but does automate some driving functions under ideal conditions like highway driving. A semi-autonomous vehicle may use “autopilot” features. In one embodiment, semi-autonomous vehicles may be able to keep in lane, and they may also be able to park themselves, but they are not self-driving. The semi-autonomous vehicles act independently to some degree.

As used herein the term “connection” as used herein refers to a communication link. It refers to a communication channel that connects two or more devices for the purpose of data transmission. It may refer to a physical transmission medium such as a wire, or to a logical connection over a multiplexed medium such as a radio channel in telecommunications and computer networking. A channel is used for information transfer of, for example, a digital bit stream, from one or several senders to one or several receivers. A channel has a certain capacity for transmitting information, often measured by its bandwidth in Hertz (Hz) or its data rate in bits per second. For example, a Vehicle-to-Vehicle (V2V) communication may wirelessly exchange information about the speed, location and heading of surrounding vehicles.

As used herein “Machine learning” refers to algorithms that give a computer the ability to learn without being explicitly programmed, including algorithms that learn from and make predictions about data. Machine learning techniques include, but are not limited to, support vector machine, artificial neural network (ANN) (also referred to herein as a “neural net”), deep learning neural network, logistic regression, discriminant analysis, random forest, linear regression, rules-based machine learning, Naïve Bayes, nearest neighbor, decision tree, decision tree learning, and hidden Markov, etc. For the purposes of clarity, algorithms such as linear regression or logistic regression can also be used as part of a machine learning process. However, it is understood that using linear regression or another algorithm as part of a machine learning process is distinct from performing a statistical analysis such as regression with a spreadsheet program. The machine learning process can continually learn and adjust the classifier as new data becomes available and does not rely on explicit or rules-based programming. The ANN may be featured with a feedback loop to adjust the system output dynamically as it learns from the new data as it becomes available. In machine learning, backpropagation and feedback loops are used to train the Artificial Intelligence/Machine Learning (AI/ML) model, improving the model's accuracy and performance over time.

The term “protocol” as used herein refers to a procedure required to initiate and maintain communication; a formal set of conventions governing the format and relative timing of message exchange between two communications terminals; a set of conventions that govern the interaction of processes, devices, and other components within a system; a set of signaling rules used to convey information or commands between boards connected to the bus; a set of signaling rules used to convey information between agents; a set of semantic and syntactic rules that determine the behavior of entities that interact; a set of rules and formats (semantic and syntactic) that determines the communication behavior of simulation applications; a set of conventions or rules that govern the interactions of processes or applications within a computer system or network; a formal set of conventions governing the format and relative timing of message exchange in a computer system; a set of semantic and syntactic rules that determine the behavior of functional units in achieving meaningful communication; a set of semantic and syntactic rules for exchanging information.

As used herein, the term “component” broadly construes hardware, firmware, and/or a combination of hardware, firmware, and software.

The embodiments described herein can be directed to one or more of a system, a method, an apparatus, and/or a computer program product at any possible technical detail level of integration. The computer program product can include a computer-readable storage medium (or media) having computer-readable program instructions thereon for causing a processor to carry out aspects of the one or more embodiments described herein. The computer-readable storage medium can be a tangible device that can retain and store instructions for use by an instruction execution device. For example, the computer-readable storage medium can be, but is not limited to, an electronic storage device, a magnetic storage device, an optical storage device, an electromagnetic storage device, a superconducting storage device, and/or any suitable combination of the foregoing. A non-exhaustive list of more specific examples of the computer-readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer-readable storage medium, as used herein, does not construe transitory signals per se, such as radio waves and/or other freely propagating electromagnetic waves, electromagnetic waves propagating through a waveguide and/or other transmission media (e.g., light pulses passing through a fiber optic cable), and/or electrical signals transmitted through a wire.

Computer-readable program instructions described herein are downloadable to respective computing/processing devices from a computer-readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device. Computer-readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer-readable program instructions can execute entirely on a computer, partly on a computer, as a standalone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field programmable gate arrays (FPGA), and/or programmable logic arrays (PLA) can execute the computer-readable program instructions by utilizing state information of the computer-readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. Each block of the flowchart illustrations and/or block diagrams, and combinations of blocks in the flowchart illustrations and/or block diagrams, can be implemented by computer-readable program instructions. These computer-readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer-readable program instructions can also be stored in a computer-readable storage medium that can direct a computer, a programmable data processing apparatus and/or other devices to function in a particular manner, such that the computer-readable storage medium having instructions stored therein can comprise an article of manufacture including instructions which can implement aspects of the function/act specified in the flowchart and/or block diagram block or blocks. The computer-readable program instructions can also be loaded onto a computer, other programmable data processing apparatus and/or other device to cause a series of operational acts to be performed on the computer, other programmable apparatus and/or other device to produce a computer-implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality, and/or operation of possible implementations of systems, computer-implementable methods and/or computer program products and/or data processing device which may be a core computer according to one or more embodiments described herein. In this regard, each block in the flowchart or block diagrams can represent a module, segment, and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions. Some of the operations of the method may be performed in the cloud, or by some other remote server.

While the subject matter described herein is in the general context of computer-executable instructions of a computer program product that runs on a computer and/or computers, those skilled in the art will recognize that the one or more embodiments herein can also be implemented in combination with one or more other program modules. Program modules include routines, programs, components, data structures, and/or the like that perform particular tasks and/or implement particular abstract data types. Moreover, other computer system configurations, including single-processor and/or multi-processor computer systems, mini-computing devices, mainframe computers, as well as computers, hand-held computing devices (e.g., PDA, phone), microprocessor-based or programmable consumer and/or industrial electronics and/or the like can practice the herein described computer-implemented methods. Distributed computing environments, in which remote processing devices linked through a communications network perform tasks, can also practice the illustrated aspects. However, standalone computers can practice one or more, if not all, aspects of the one or more embodiments described herein. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer-readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

As it is employed in the subject specification, the term “processor” can refer to any computing processing unit and/or device comprising, but not limited to, single-core processors; single-processors with software multi-thread execution capability; multi-core processors; multi-core processors with software multi-thread execution capability; multi-core processors with hardware multi-thread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular based transistors, switches, and/or gates, in order to optimize space usage and/or to enhance performance of related equipment. A combination of computing processing units can implement a processor.

Herein, terms such as “store,” “storage,” “data store,” data storage,” “database,” and any other information storage component relevant to operation and functionality of a component refer to “memory components,” entities embodied in a “memory,” or components comprising a memory. Memory and/or memory components described herein can be either volatile memory or non-volatile memory or can include both volatile and non-volatile memory. By way of illustration, and not limitation, non-volatile memory can include read-only memory (ROM), programmable ROM (PROM), electrically programmable ROM (EPROM), electrically erasable ROM (EEPROM), flash memory, and/or non-volatile random access memory (RAM) (e.g., ferroelectric RAM (FeRAM). Volatile memory can include RAM, which can function as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synch link DRAM (SLDRAM), direct Rambus RAM (DRRAM), direct Rambus dynamic RAM (DRDRAM) and/or Rambus dynamic RAM (RDRAM). Additionally, the memory components described of systems and/or computer-implemented methods herein include, without being limited to including, these and/or any other suitable types of memory.

The descriptions of the one or more embodiments are for purposes of illustration but are not exhaustive or limiting to the embodiments described herein. Many modifications and variations will be apparent to those of ordinary skill in the art without departing from the scope and spirit of the embodiments described. The terminology used herein best explains the principles of the embodiments, the practical application and/or technical improvement over technologies found in the marketplace, and/or enable others of ordinary skill in the art to understand the embodiments described herein.

According to aspects, the data processing capabilities of a vehicle are generally provided by a one, centralized, or more than one, communicatively coupled, core computer and optionally one or more communicatively coupled Control Units (CUs). This is generally referred to as distributed data processing. The CUs may also act as gateways that translate and forward commands, and other information, from the core computer to the intended CU, which in turn control the behavior of a specific device or functionality. The CUs may be located in different parts of the vehicle and may be related to one or more particular functionality of the vehicle, hence, be referred to as, for example, Engine Control Unit (ECU), Braking (System) Control Unit (BCU), Vehicle Control Unit (VCU), Propulsion (System) Control Unit (PCU). The responsibility of the core computer is for example to coordinate and control the internal systems of the vehicle, including controlling how information is shared between the vehicle systems and various components of the vehicle. The core computer may, for example, be responsible for controlling torque requested/delivered by an electric propulsion motor, control friction and regenerative brakes, control internal and external lighting, and for climate control. This is generally enabled by collecting input from various sensors and systems of the vehicle, and by sending requests and instructions to different actuators of the vehicle using vehicle internal communication protocols (such as, for example, but not limited to, ethernet and IPv4). The skilled person will also appreciate that at least some parts of the data processing capabilities of a vehicle may be implemented as a functionality at a remote server, for example as a functionality implemented in a cloud or edge cloud architecture, to which the vehicle internal data processing system of the vehicle is communicatively connected. For such implementations, obviously information needs to be communicated between the vehicle internal data processing system and the remote server. For the sake of simplicity, the system providing data processing capabilities is herein generally referred to as a data processing device.

Business Problem: In the transportation industry, especially for electric vehicles (EVs), it is essential to optimize the charging process to meet specific departure schedules. However, current charging systems often lack dynamic adaptability and fail to account for real-time information such as energy consumption, traffic, and battery performance. As a result, there is a risk of the vehicle not reaching the desired battery level before the planned departure time, leading to potential delays, customer dissatisfaction, and reduced operational efficiency. There is a need for a smarter, more efficient way to calculate and manage vehicle battery charging schedules.

Business Solution: The proposed solution involves a system that computes a charging schedule in real-time, considering current conditions, to ensure the vehicle's battery reaches the target battery level before the scheduled departure time. The solution enables dynamic adjustment of the charging process based on real-time information, such as energy consumption patterns, time of day, traffic conditions, battery parameters, grid parameters, user preferences, usage patterns, or charging station availability. The solution guarantees that vehicles are optimally charged prior to the departure time. This helps enhance operational efficiency, minimize delays, and increase customer satisfaction, ultimately providing a competitive advantage in the electric vehicle sector.

Technical Problem: Electric vehicles require a charging process that adapts to changing conditions such as varying battery charge levels, energy usage patterns, real-time vehicle performance, and environmental factors. Existing systems typically rely on fixed charging schedules or simple algorithms that do not adjust for real-time data, leading to inefficiencies in energy usage and potentially failing to meet the desired target battery levels within the required departure time. The challenge lies in developing a solution that can compute a charging schedule dynamically, incorporating real-time information to optimize the charging process while ensuring timely departure.

Technical Solution: The proposed system involves computing a charging schedule based on real-time data. This includes monitoring and analyzing the current battery charge level, energy consumption patterns, environmental conditions, and departure time. The system then dynamically adjusts the charging rate, charging time, and charging duration to ensure that the vehicle reaches its target battery level exactly when needed, without overcharging or undercharging. The charging schedule is calculated in real-time, factoring in any external constraints and current conditions to optimize the charging process for efficiency and timeliness.

Technical Result: The present disclosure provides a highly optimized charging schedule that ensures the vehicle reaches the target battery level within the required time. By factoring in real-time data, such as energy consumption, CO2 emission, usage patterns, user preferences, battery parameters, grid parameters, and external conditions, the system minimizes charging time while ensuring the vehicle's battery is sufficiently charged before departure. This improves the vehicle's operational efficiency, reduces downtime, and ensures a consistent and reliable service, even in changing conditions. The result is a more efficient, flexible, and responsive charging process that meets the dynamic needs of modern electric vehicles.

How Technical Solution is a Technological Advancement?: This solution represents a technological advancement because it integrates real-time information into the charging process, which is not typically done in conventional systems. Current systems often rely on static charging schedules that do not adapt to fluctuating variables such as energy usage, traffic, or other environmental conditions. The ability to compute a charging schedule in real-time, considering these factors, enhances charging efficiency and ensures timely departures, representing a significant leap forward in how electric vehicles manage battery charging. This approach combines real-time monitoring with predictive charging algorithms, providing a smarter, more responsive charging infrastructure that is better suited to modern-day needs, offering improved energy efficiency, cost-effectiveness, and user satisfaction.

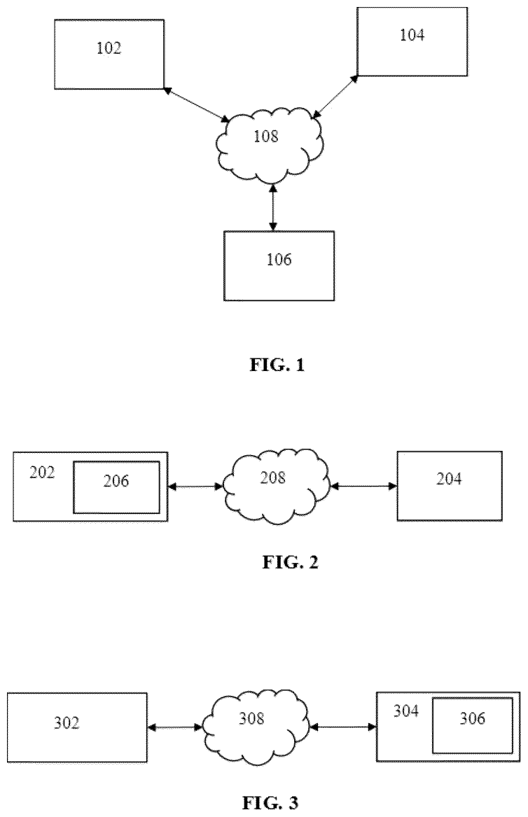

In an aspect, a system is described. As an example, FIG. 1 illustrates a system comprising a server in the cloud, according to one or more embodiments. The system 100 comprises a vehicle 102, an electric vehicle supply equipment (EVSE) 104, and a server 106. The server 106 may reside in a cloud. According to this embodiment, the server 106 resides external to both the vehicle 102 and the electric vehicle supply equipment (EVSE) 104. The server 106 may communicate with the vehicle 102 and the EVSE 104 through a network 108. The network 108 may be a wireless network.

The server 106 may receive one or more inputs from a user. In an embodiment, one or more inputs may be extracted from an external system. For example, the user inputs departure time, target battery level, etc., which may be extracted from an itinerary information of a user/vehicle. The server 106 determines one or more factors in accordance with one or more inputs. The one or more factors may be components/parameters that influence the charging schedule. The server 106 then computes real-time information in accordance with the one or more factors. The server 106 computes the charging schedule in accordance with the real-time information to charge one or more battery packs of a vehicle to the target battery level within, and prior to, the departure time of the vehicle.

The system 100 may comprise a sensor module. The sensor module may be associated with one of the vehicle 102 and the EVSE 104. The sensor module may be configured to monitor at least one of battery parameters, grid parameters, user preferences, etc. The server 106 may receive sensory information from the sensor module. The server 106 may compute the charging schedule in accordance with the real-time information and the sensory information to charge one or more battery packs of the vehicle 102 to the target battery level within the departure time of the vehicle 102.

As an example, FIG. 2 illustrates a system comprising a server 206 within a vehicle 202, according to one or more embodiments. The system 200 comprises a vehicle 202, an electric vehicle supply equipment (EVSE) 204, and a server 206. According to this embodiment, the server 206 resides within the vehicle 202. The server 206 may communicate with the EVSE 204 through a network 208. The network 208 may be a wireless network. The vehicle computer system of the vehicle 202 communicates with the server 206 through a wired connection.

The server 206 may receive one or more inputs from a user through a dashboard. The server 206 may receive the one or more inputs from the user through an external device (e.g., smartphone, tablet, personal digital assistant, etc.). The server 206 may be part of a vehicle computer system. In an embodiment, the one or more inputs may be extracted from an external system. For example, the user inputs departure time, target battery level, etc., which may be extracted from an itinerary information of a user/vehicle. The server 206 determines one or more factors in accordance with the one or more inputs. The one or more factors may be components/parameters that influence the charging schedule. The server 206 then computes real-time information in accordance with the one or more factors. The server 206 computes the charging schedule in accordance with the real-time information to charge one or more battery packs of a vehicle to the target battery level within the departure time of the vehicle.

The system 200 may comprise a sensor module. The sensor module may be associated with one of the vehicle 202 and the EVSE 204. The sensor module may be configured to monitor at least one of battery parameters, grid parameters, user preferences, etc. The server 206 may receive sensory information from the sensor module. The server 206 may compute the charging schedule in accordance with the real-time information and the sensory information to charge one or more battery packs of the vehicle 202 to the target battery level within the departure time of the vehicle 202.

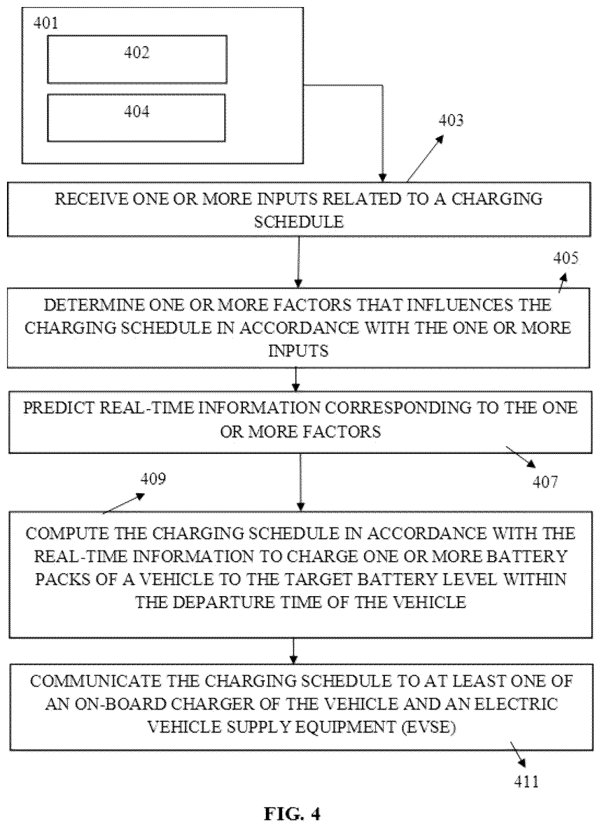

As an example, FIG. 3 illustrates a system, according to one or more embodiments. The system 300 comprises a vehicle 302, an electric vehicle supply equipment (EVSE) 304, and a server 306. According to this embodiment, the server 306 resides within the electric vehicle supply equipment (EVSE) 304. The server 306 may be part of the electric vehicle supply equipment (EVSE) 304. The server 306 may communicate with the vehicle 302 through a network 308. The network 308 may be a wireless network. The electric vehicle supply equipment (EVSE) 304 communicates with the server 306 through a wired connection.

The server 306 may receive one or more inputs from a user through a dashboard of a vehicle computer system. The server 306 may receive the one or more inputs from the user through an external device (e.g., smartphone, tablet, personal digital assistant, etc.). In an embodiment, the one or more inputs may be extracted from an external system. For example, the user inputs such as departure time, target battery level, etc., may be extracted from an itinerary information of a user/vehicle. The server 306 determines one or more factors in accordance with one or more inputs. The one or more factors may be components/parameters that influence the charging schedule. The server 306 then computes real-time information in accordance with the one or more factors. The server 306 computes the charging schedule in accordance with the real-time information to charge one or more battery packs of a vehicle to the target battery level within the departure time of the vehicle.

The system 300 may comprise a sensor module. The sensor module may be associated with one of the vehicle 302 and the EVSE 304. The sensor module may be configured to monitor at least one of battery parameters, grid parameters, user preferences, etc. The server 306 may receive sensory information from the sensor module. The server 306 may compute the charging schedule in accordance with the real-time information and the sensory information to charge one or more battery packs of the vehicle 302 to the target battery level within the departure time of the vehicle 302.

As an example, FIG. 4 illustrates a system, according to one or more embodiments. The system 401 comprises a server. The server comprises: a processor 402 and a non-transitory memory 404. The processor 402 stores instructions in non-transitory memory 404 that, when executed, cause the processor 402 to execute the following technical steps. At step 403, the processor 402 is configured to receive one or more inputs related to a charging schedule. At step 405, the processor 402 is configured to determine one or more factors that influence the charging schedule in accordance with the one or more inputs. At step 407, the processor 402 is configured to predict real-time information corresponding to the one or more factors. At step 409, the processor 402 is configured to compute the charging schedule in accordance with the real-time information to charge one or more battery packs of a vehicle to the target battery level within the departure time of the vehicle. At step 411, the processor 402 is configured to communicate the charging schedule to at least one of an on-board charger of the vehicle and an Electric Vehicle Supply Equipment (EVSE). The one or more inputs comprises a departure time, a target battery level, and one or more user preferences. The one or more factors comprises at least one of a charging time, a charging duration, an itinerary, a charging cost, one or more battery parameters, one or more grid parameters, one or more usage patterns, and one or more external conditions.

In an embodiment, the processor 402 is operable to receive the one or more inputs from a user through a user interface. In another embodiment, the processor 402 is operable to receive the one or more inputs through one of a personal digital assistant and a vehicle computer system. The personal digit assistant may be one of a smartphone, a tablet, a personal computer, a desktop, a smartwatch, etc. The vehicle computer system is an embedded system in automotive electronics that controls one or more of the electrical systems or subsystems in a vehicle. The vehicle computer system executes a large number of different software functions in the powertrain, chassis, driver assistance, and infotainment domains, etc., that are executed on separate control units. The vehicle computer system may be communicatively coupled with an external device (e.g., personal digital assistant) of a user. The vehicle computer system may also be communicatively coupled with the charging station. The vehicle computer system comprises infotainment system, human-machine interface (HMI), diagnostic systems, power supply, communication network system, and electronic control unit.

In an embodiment, the processor 402 is operable to determine the one or more inputs from an itinerary of the vehicle. For example, the processor 402 may determine the departure time and the target battery level from the itinerary of the vehicle based on one of an upcoming halt location and an upcoming destination. The processor 402 may calculate the departure time, and the target battery level required to reach one of the upcoming halt locations and the upcoming destination based on charge per distance.

In another embodiment, the processor 402 is operable to extract the one or more inputs from an external system (e.g., external database). For example, the user inputs departure time, target battery level, etc., which may be extracted from an itinerary information of a user/vehicle. The external database may store the itinerary information of the user. The processor 402 is configured to extract the one or more inputs upon verifying the authentication of the user. The processor 402 is configured to determine the one or more inputs based on the usage pattern of the user (e.g., charging routine, daily routine, etc.). Based on the usage pattern of the vehicle, the processor 402 determines the departure time. For example, the processor 402, using a GPS within the vehicle, monitors the movement of the vehicle and records it in a database. The processor 402 at a later point of time determines the average departure time based on the data recorded in the database. The processor 402 considers the average departure time as the input. For example, the processor 402, using a BMS within the vehicle and the GPS, monitors the battery level (i.e., state-of-charge (SoC)) of the vehicle at the departure times. The processor 402 then determines the average target battery level required based on the data recorded in the database. Similarly, the processor 402 determines the one or more user preferences based on analyzing the usage patterns and the history of the charging of the vehicle.

The processor 402 then determines the one or more factors that influence the charging schedule in accordance with the one or more inputs. In an embodiment, the one or more factors comprises at least one of a charging time, a charging duration, an itinerary, a charging cost, a state-of-health, a state-of-charge, a battery temperature, a charging temperature, and an ambient temperature, grid constraints, energy-mix CO₂, battery constraints, peak demand hours, off-demand hours, etc. The processor 402 analyzes the one or more inputs and determines the one or more factors that can impact the charging schedule. The one or more factors may be segregated into vehicle factors and external factors. The vehicle factors comprise the charging time, the charging duration, the itinerary, a state-of-health, a state-of-charge, a battery temperature, a charging temperature, battery aging, battery degradation, and an ambient temperature. The external factors comprise charging cost, grid constraints, energy-mix CO₂, peak demand hours, off-demand hours, etc.

As an example, the processor 402, upon receiving the departure time as the input, the processor 402 may determine that the charging time and charging duration may vary based on the departure time. If the user input (i.e., departure time) is 1 hour earlier than the usual time, the processor 402 determines that the charging time and the charging duration varies in order to charge the vehicle to the target battery level. The processor 402 determines that the charging time and the charging duration are the factors that influence the charging schedule. Accordingly, the processor 402 predicts the real-time information (i.e., current timing let us say 2.00 PM EST) and computes the charging schedule 1 hour earlier to charge the one or more battery packs of the vehicle to the target battery level within the departure time of the vehicle.

As another example, the processor 402, upon receiving the target battery level as the input, the processor 402 may determine that the charging time, the charging duration, a state-of-health, and a battery temperature, may influence the charging schedule. If the user input (i.e., target battery level) is 95%, the processor 402 determines that the charging time, the charging duration, a state-of-health, battery temperature influence the charging schedule. The processor 402 determines that the charging time, the charging duration, a state-of-health, and battery temperature are the factors that influence the charging schedule. Accordingly, the processor 402 predicts the real-time information (i.e., state-of-charge let's say 20% and battery temperature 5 degree Celsius) and computes the charging schedule with charging sequence that adapts both battery temperature and the charging level (e.g., regular charging) to charge the one or more battery packs of the vehicle to the target battery level within the departure time of the vehicle.

The users do not have a deep understanding of the fluctuation of electricity price, battery degradation, auxiliary load consumption of EV during charging and CO₂ emission of the energy-mix. The processor 402 of the server eliminates the need for the understanding of the above factors by computing the optimized charging schedule based on selected criteria (such as reducing electricity cost, CO₂, battery aging, or a combination of selected criteria). The processor 402 receives those settings/inputs configured by the user via the mobile application or a vehicle computer system.

The processor 402 as explained above predicts the real-time information corresponding to the one or more factors. The processor 402 is configured to receive or predict the information used for computing the schedule, such as the future electricity price, CO₂ emission, battery temperature, ambient temperatures and/or power constraints in the electricity grid. In an example, the processor 402 may predict the real-time information (i.e., the electricity tariff) at instant time (e.g., peak demand hours, off-demand hours, etc.) when the electricity cost is determined as the factor that influences the charging schedule. In another example, the processor 402 may predict the real-time information (i.e., the state-of-charge at instant time) when at least one of the state-of-health, the state-of-charge, and the battery temperature is determined as the factor that influences the charging schedule. In an embodiment, the processor is operable to receive the real-time information corresponding to the one or more factors from one of an external system and an external database.

The processor 402 then computes the charging schedule in accordance with the real-time information to charge one or more battery packs of a vehicle to the target battery level within the departure time of the vehicle. The charging schedule comprises a charging duration, a charging session start time, a charging session end time, a charging location, the target battery level, and a charging sequence. The charging sequence comprises one or more charging levels for one or more predefined portions of the one or more battery packs. A charging level may be a regular charging, a fast charging, or a trickle charging. In an example, the processor 402 computes the charging schedule having the charging sequence as regular charging when at least one of the state-of-health, the state-of-charge, and the battery temperature is determined as the factor that influences the charging schedule. If at least one of the state-of-health, the state-of-charge, and the battery temperature is in good state, the charging schedule is computed with the charging sequence as fast charging. In another example, the processor 402 computes the charging schedule having the modified charging time adjusted according to the electricity cost when the electricity tariff at instant time is higher than user preferred cost. The processor 402 computes the modified charging time (e.g., 1 hour in advance or later) such that the departure time is not exceeded, and the charging cost is within the user preferred range. Only a few examples have been illustrated above. However, there are multiple scenarios where the charging schedule is computed considering both the external factors and the vehicle factors. The processor 402 may determine the target battery level based on at least one of the usage pattern, daily routine, battery specification, state-of-health of the battery pack, or itinerary. The processor 402 may determine the departure time based on at least one of the usage pattern, daily routine, or itinerary. In an embodiment, the processor 402 enables the user to either set/configure the departure time and the target battery level at the departure through the user interface.

The processor 402 primarily focuses on charging one or more battery packs of a vehicle to the target battery level within the departure time of the vehicle. The real-time information may impact the computation of the charging schedule. For example, the processor 402 may compute and alter the charging schedule (e.g., charging is scheduled 1 hour in advance), if the charging cost is high at expected/usual charging time. For example, the processor 402 may compute and alter the charging schedule (e.g., charging is scheduled 1 hour later), if the departure time is later than the expected/usual departure time.

The processor 402 then communicates the charging schedule to at least one of an on-board charger of the vehicle and an Electric Vehicle Supply Equipment (EVSE). The system may comprise a communication controller to communicate with the vehicle and the Electric Vehicle Supply Equipment (EVSE). Similarly, the vehicle and the EVSE may also comprise a communication controller separately to interact with each other.

In one embodiment, the system resides in a cloud. According to this embodiment, the system is communicatively coupled to the vehicle and the Electric Vehicle Supply Equipment (EVSE). The processor 402 may communicate the charging schedule to the vehicle and the Electric Vehicle Supply Equipment (EVSE). In an embodiment, the processor 402 is operable to communicate the charging schedule to the Electric Vehicle Supply Equipment (EVSE) when a connection is established between the vehicle and the Electric Vehicle Supply Equipment (EVSE). The connection may be established between the vehicle and the Electric Vehicle Supply Equipment (EVSE) when the EVSE is within the predefined radius of the vehicle.

The EVSE upon receiving the charging schedule reserves the charging slot for the vehicle. The charging schedule outlines when and how much energy should be delivered to the battery to meet specific objectives, such as reaching a target charge level, minimizing costs, or optimizing efficiency, while considering various constraints and influencing factors. The charging schedule comprises quantitative values necessary to provide instructions to respective components.

The EVSE comprises an off-board charger. The EVSE upon receiving the charging schedule from the processor 402 communicates instructions to the off-board charger to deliver power according to the quantitative values of the charging schedule. The off-board charger converts power from the grid to the required voltage as per the specification of the vehicle in accordance with the charging schedule. The vehicle comprises an on-board charger. The vehicle upon receiving the charging schedule from the processor 402 communicates instructions to the on-board charger to receive power and deliver power according to the quantitative values of the charging schedule. The on-board charger receives power from the Electric Vehicle Supply Equipment (EVSE) in accordance with the charging schedule. The on-board charger charges the one or more battery packs of the vehicle in accordance with the charging schedule.

Upon receiving the charging schedule from the processor 402, either the vehicle or the Electric Vehicle Supply Equipment (EVSE) executes charging of the one or more battery packs of the vehicle in accordance with the charging schedule. Upon receiving the charging schedule, the vehicle functions on its own and executes its portion of charging (i.e., arriving at the charging location at scheduled time and connecting to a charging plug of the EVSE). Similarly, upon receiving the charging schedule, the EVSE functions on its own and executes its portion of charging (i.e., delivering power via the charging port to the vehicle once the vehicle is plugged in or connected with the EVSE). In one embodiment, either the vehicle or the Electric Vehicle Supply Equipment (EVSE) executes charging when the EVSE is within a predefined radius of the vehicle though a connection to the cloud is disconnected. The EVSE and the vehicle synchronize through a telematics unit.

In another embodiment, the system resides in one of the vehicle or the Electric Vehicle Supply Equipment (EVSE). If the system is residing in the vehicle, the system is then communicatively coupled to the EVSE. In an embodiment, the system residing in the vehicle computes the charging schedule when the EVSE is within a predefined radius to the vehicle and a connection to a cloud is disconnected. The system is communicatively coupled to the battery management system. The battery management system analyzes the one or more battery packs of the vehicle and determines the one or more battery parameters, the one or more grid parameters, the one or more usage patterns, and the one or more external conditions. The battery management system provides a dynamic interface that determines and depicts at least one of a battery aging, a battery degradation, and a calendar battery ageing as a function of battery temperature and state-of-charge. The battery management system is also operable to coordinate with a thermal system of the vehicle and collects an auxiliary load consumption in different use cases. The battery management system is further operable to compute a first thermal strategy to predict a first auxiliary power to change temperature of one or more high voltage components. In another embodiment, the battery management system is operable to compute a second thermal strategy to predict a second auxiliary power to change the temperature of the one or more high voltage components when there is deviation in the first auxiliary power which in turn deviates from the first thermal strategy.

The one or more grid parameters comprises peak demand hours, off-peak hours, grid frequency, grid voltage, and load balancing. The one or more user preferences comprises at least one of a preferred charging duration, a CO₂ emission intensity, and a preferred charging cost range. The one or more battery parameters comprises a nominal capacity, a state-of-health, a state-of-charge, a depth-of-discharge, an energy capacity, a nominal voltage, an open circuit voltage, a cutoff voltage, a charge voltage, charge per distance, capacity rate (C-rate), internal resistance, cycle life, operating temperature range, storage temperature range, thermal runaway threshold, overcharge protection limit, over discharge protection limit, form factor, weight and energy density, charging time, and charging current. The processor 402 is operable to determine a battery specification based on the one or more battery parameters. The processor 402 is operable to calculate one of a battery aging and a battery degradation based on the state-of-health. The one or more usage patterns comprise a routine charging start time, a routine charging end time, a routine charging duration, a routine charging sequence, a routine charging location, a routine arrival time, and a routine departure time. The one or more external conditions comprise an ambient temperature, an ambient environmental condition, humidity, atmospheric pressure, Ultraviolet (UV) lighting, and vibration.

The processor 402 receives the above information from the battery management system and computes the charging schedule in accordance with the real-time information. The processor 402 then communicates the charging schedule to the EVSE to be in synchronization state to execute charging. In an embodiment, the processor 402 is operable to recommend the departure time and the target battery level based on analyzing the one or more usage patterns. The processor 402 determines the one or more upcoming halt locations, halt durations, departure time, etc., from the itinerary of the user. The processor 402 also receives the state-of-charge, the state-of-health, battery temperature from the battery management system. The processor 402 determines the target battery level based on the state-of-charge, the state-of-health, the battery temperature, the one or more upcoming halt locations, halt durations, and departure time. In one example, the processor 402 determines the target battery level as 60 percent when the state-of-charge, the state-of-health, and the battery temperature is optimal and the one or more upcoming halt locations are closer to the vehicle. In another example, the processor 402 determines the target battery level as 95 percent when the state-of-charge, the state-of-health, and the battery temperature is optimal and the one or more upcoming halt locations are far away from the vehicle. In an embodiment, the processor 402 may refer to the values (i.e., charging routine, daily travel routine) recorded within the vehicle database and the itinerary and determine the target battery level. In one embodiment, the processor 402 may comprise an artificial intelligence engine that analyzes the usage pattern and extracts the upcoming itinerary and charging pattern based on the usage pattern. Based on the extracted data, the processor 402 determines the target battery level. The processor 402 calculates the amount of charge required (e.g., target battery level) that can be charged within the departure time to complete the itinerary based on the battery parameters, user preferences, external conditions, and grid parameters. In an embodiment, the processor 402 calculates the target battery level to be charged within the departure time without damaging the battery.

The processor 402 calculates the target battery level in accordance with the real-time information of the one or more factors. In one example, the processor 402 calculates the target battery level as 80 percent when 70 percent of charge is sufficient to complete the itinerary and the charging cost is high. In another example, the processor 402 calculates the target battery level as 90 percent when 60 percent of charge is sufficient to complete the itinerary and the charging cost is low and has sufficient timing to charge. The processor 402 calculates the target battery level and the charging schedule according to the scenario. The processor 402 primarily focuses on charging the one or more battery packs of the vehicle to the target battery level within the departure time.

In an embodiment, the processor 402 computes the charging schedule that can charge the battery packs to the target battery level within the departure time without damaging the battery packs. In an embodiment, the processor 402 is operable to compute the charging schedule to reduce a battery aging of the one or more battery packs when a connection to a cloud is lost and unable to predict the real-time information corresponding to the one or more factors. In one example, the processor 402 is operable to compute the charging schedule as a regular charging when the state-of-health of the battery pack is low.

In an embodiment, the vehicle communicates the charging schedule to the Electric Vehicle Supply Equipment (EVSE) and receives charging from the Electric Vehicle Supply Equipment (EVSE) in accordance with the charging schedule when the EVSE is within a predefined radius of the vehicle.

If the system is residing in the EVSE, the system is then communicatively coupled to the vehicle. The system communicates the instructions to the battery management system and receives information from the vehicle. The processor 402 then computes the charging schedule in accordance with the real-time information. The processor 402 communicates the charging schedule to the vehicle to be in synchronization state to execute charging. The processor 402 is operable to communicate the charging schedule to the vehicle when a connection is established between the vehicle and the cloud. In an embodiment, the Electric Vehicle Supply Equipment (EVSE) communicates the charging schedule to the vehicle and supplies charging to the vehicle in accordance with the charging schedule when the EVSE is within a predefined radius of the vehicle.

The processor 402 is operable to communicate a first command to the Electric Vehicle Supply Equipment (EVSE) to send an Electric Vehicle Supply Equipment Identification (EVSE ID) to the vehicle and the processor 402. The processor 402 communicates a second command to the vehicle to validate the Electric Vehicle Supply Equipment Identification (EVSE ID) and pair the vehicle and the Electric Vehicle Supply Equipment (EVSE) in the cloud. The pairing may be done through the Open Charge Point Protocol (OCPP). The OCPP is the Common protocol for communication between the EVSE and the cloud. The processor 402 pairs the EV and the EVSE in the cloud by executing the following technical steps. A) Authentication and identification: The EV must be authenticated before performing any action. The authentication can happen through one of RFID card, mobile application, plug and charge (ISO 15118), and manual entry in cloud dashboard. B) Establishing secure communication: The communication between EVSE to cloud may be established using OCPP. The communication between EV to EVSE may be established using ISO 15118 for Plug & Charge or basic connection via IEC 61851. The EVSE sends pairing requests to the cloud when a new EV is detected. C) Pairing & Data Exchange: Once paired, the EV and EVSE shares: Charging status; Power requirements; Billing information; State of Charge (SoC); and Charge scheduling preferences. Once paired, the vehicle and the EVSE are in synchronization state. The activity executed in the vehicle is updated to the EVSE via the telematics unit. Similarly, the activity executed in the EVSE is updated to the vehicle via the telematics unit.

Since both the vehicle and the EVSE are in synchronization state, the processor 402 communicates data only to requisite components to conserve energy. In an embodiment, the processor 402 is operable to communicate data of arbitrary length of different data types to the vehicle through a communication channel. The processor 402 is operable to enable one or more first components of the vehicle to be awake and receive the data while enabling one or more second components to enter sleep mode and conserve energy.

In another embodiment, the processor 402 is operable to enable a user to set weight for the one or more user preferences through a user interface. The processor 402 computes the charging schedule based on the weight set by the user using the cost equation. The cost equation is as follows:

$${Cost}_{equivalant} = {a}_{1} * {Co st}_{electicity} + {a}_{2} * {Cost}_{CO 2} + {a}_{3} * {Cost}_{BattAging}$$

The cost equation is adapted to arbitrate the electricity price, CO₂ emission cost, and battery aging cost. The processor 402 enables the user to have flexibility to set weight for them respectively via the cost equation. The processor 402 may interface to the user via the external device (e.g., personal digital assistant) or the vehicle computer system (e.g., infotainment system). The user may set weight to those variables by dropping down and selecting the values. The processor 402 may also enable the user to set weight by directly entering the quantitative values onto the input fields corresponding to those variables. The processor 402 computes the charging schedule based on the weight set by the user.

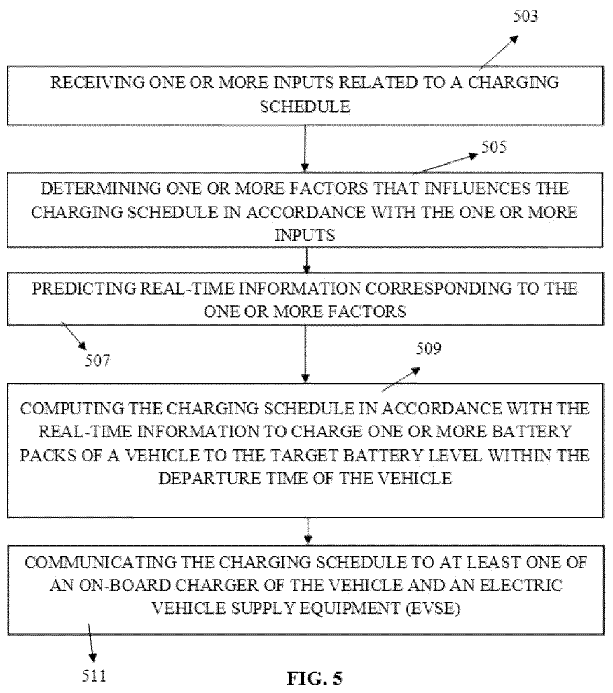

As an example, FIG. 5 illustrates a method, according to one or more embodiments. The method comprises the following technical steps: receiving, by a processor, one or more inputs related to a charging schedule (at step 503); determining, by the processor, one or more factors that influence the charging schedule in accordance with the one or more inputs (at step 505); predicting, by the processor, real-time information corresponding to the one or more factors (at step 507); computing, by the processor, the charging schedule in accordance with the real-time information, the one or more battery parameters, the one or more usage patterns, and the one or more external conditions to charge one or more battery packs of a vehicle to the target battery level within the departure time of the vehicle (at step 509); and communicating, by the processor, the charging schedule to at least one of an on-board charger of the vehicle and an Electric Vehicle Supply Equipment (EVSE) (at step 511). The one or more inputs comprises a departure time, a target battery level, and one or more user preferences. The one or more factors comprises at least one of a charging time, a charging duration, an itinerary, a charging cost, one or more battery parameters, one or more grid parameters, one or more usage patterns, and one or more external conditions.

In an embodiment, the method further comprises: determining, by the processor, the one or more inputs from an itinerary of the vehicle. In an example, the method comprises: determining, by the processor, the departure time, and the target battery level from the itinerary of the vehicle based on one of an upcoming halt location and an upcoming destination. In another example, the method comprises: determining, by the processor, the departure time, and the target battery level required to reach one of the upcoming halt location and the upcoming destination based on charge per distance.

The method further comprises: analyzing, by a battery management system, the one or more battery packs of the vehicle and determining the one or more battery parameters, the one or more grid parameters, the one or more usage patterns, and the one or more external conditions. The method may further comprise: determining, by the processor, a battery specification based on the one or more battery parameters. The method may further comprise: calculating, by the processor, one of a battery aging and a battery degradation based on a state-of-health. The method further comprises: recommending, by the processor, the departure time, and the target battery level based on analyzing the one or more usage patterns. The method further comprises: receiving, by the processor, the real-time information corresponding to the one or more factors from one of an external system and an external database.

In one embodiment, the method further comprises: receiving, by the processor, the one or more inputs from a user through a user interface (e.g., vehicle computer system). In another embodiment, the method further comprises: receiving, by the processor, the one or more inputs through one of a personal digital assistant and a vehicle computer system.

The method further comprises pairing the EVSE and the vehicle by executing the following technical steps. The technical steps comprises: communicating a first command to the Electric Vehicle Supply Equipment (EVSE) to send an Electric Vehicle Supply Equipment Identification (EVSE ID) to the vehicle and the processor; and communicating a second command to the vehicle to validate the Electric Vehicle Supply Equipment Identification (EVSE ID) and pair the vehicle and the Electric Vehicle Supply Equipment (EVSE). The method further comprises: executing, by one of the vehicle and the Electric Vehicle Supply Equipment (EVSE), the charging of the one or more battery packs of the vehicle in accordance with the charging schedule when the EVSE is within a predefined radius of the vehicle when a connection to the cloud is disconnected.

Upon pairing the EVSE and the vehicle, the method may execute the following technical steps. The technical steps comprise: receiving, by the on-board charger, power from the Electric Vehicle Supply Equipment (EVSE) in accordance with the charging schedule. The method further comprises: charging, by the on-board charger, the one or more battery packs of the vehicle in accordance with the charging schedule.

In an embodiment, the method further comprises: communicating, by the processor, data of arbitrary length of different data types to the vehicle through a communication channel. The method further comprises: enabling, by the processor, one or more first components of the vehicle to be awake and receiving the data while enabling one or more second components to enter sleep mode and conserve energy.

In an embodiment, the method further comprises: providing, by the battery management system, a dynamic interface that determines and depicts at least one of a battery aging, a battery degradation, and a calendar battery ageing as a function of battery temperature and state-of-charge. The method further comprises: coordinating, by the battery management system, with a thermal system of the vehicle that collects an auxiliary load consumption in different use cases. The method further comprises: computing, by the battery management system, a first thermal strategy to predict a first auxiliary power to change temperature of one or more high voltage components. The method further comprises: computing, by the battery management system, a second thermal strategy to predict a second auxiliary power to change the temperature of the one or more high voltage components when there is deviation in the first auxiliary power which in turn deviates from the first thermal strategy.

In one embodiment, the method further comprises: computing, by the processor, the charging schedule to reduce a battery aging of the one or more battery packs when a connection to a cloud is lost and unable to predict the real-time information corresponding to the one or more factors.

In another embodiment, the method further comprises: enabling, by the processor, a user to set weights for the one or more user preferences through a user interface. According to this embodiment, the method further comprises: computing, by the processor, the charging schedule based on the weights set by the user.

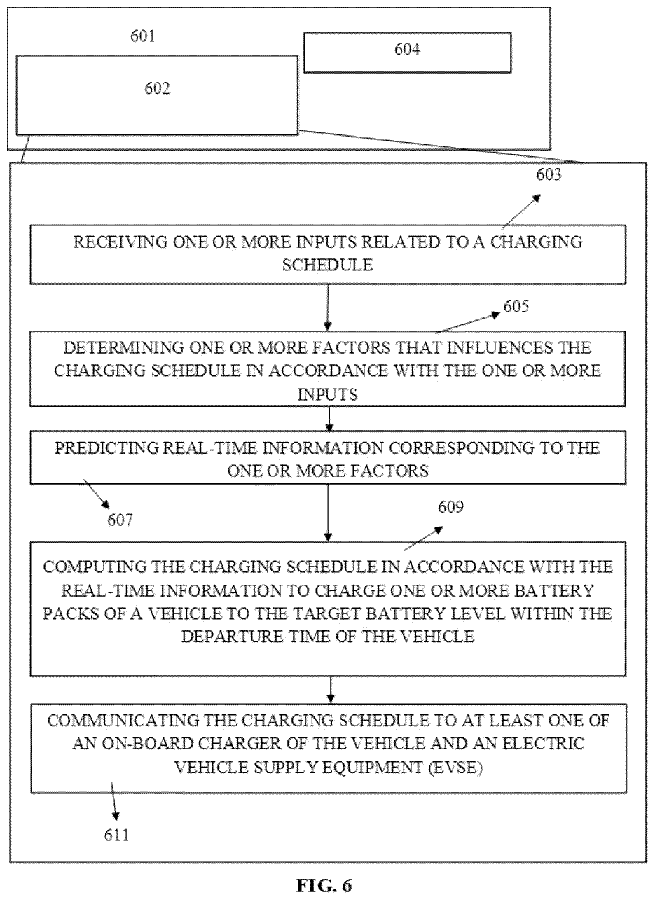

As an example, FIG. 6 illustrates a computer system comprising a non-transitory computer-readable storage medium, according to one or more embodiments. The computer system 601 comprises a non-transitory computer-readable storage medium 602 comprising a sequence of instructions, which when executed by a processor 604 causes: receiving one or more inputs related to a charging schedule (at step 603); determining one or more factors that influence the charging schedule in accordance with the one or more inputs (at step 605); predicting real-time information corresponding to the one or more factors (at step 607); computing the charging schedule in accordance with the real-time information, the one or more battery parameters, the one or more usage patterns, and the one or more external conditions to charge one or more battery packs of a vehicle to the target battery level within the departure time of the vehicle (at step 609); and communicating the charging schedule to at least one of an on-board charger of the vehicle and an Electric Vehicle Supply Equipment (EVSE) (at step 611). The one or more inputs comprises a departure time, a target battery level, and one or more user preferences. The one or more factors comprises at least one of a charging time, a charging duration, an itinerary, a charging cost, one or more battery parameters, one or more grid parameters, one or more usage patterns, and one or more external conditions.

The non-transitory computer-readable storage medium further causes: analyzing the one or more battery packs of the vehicle and determining the one or more battery parameters, the one or more grid parameters, the one or more usage patterns, and the one or more external conditions. In one example, the non-transitory computer-readable storage medium further causes: determining a battery specification based on the one or more battery parameters. In another example, the non-transitory computer-readable storage medium further causes: calculating one of a battery aging and a battery degradation based on a state-of-health.

The non-transitory computer-readable storage medium further causes: communicating a first command to the Electric Vehicle Supply Equipment (EVSE) to send an Electric Vehicle Supply Equipment Identification (EVSE ID) to the vehicle and the processor; and communicating a second command to the vehicle to validate the Electric Vehicle Supply Equipment Identification (EVSE ID) and pair the vehicle and the Electric Vehicle Supply Equipment (EVSE).

The non-transitory computer-readable storage medium further causes: receiving power from the Electric Vehicle Supply Equipment (EVSE) in accordance with the charging schedule. The non-transitory computer-readable storage medium further causes: charging, by the on-board charger, the one or more battery packs of the vehicle in accordance with the charging schedule.

The non-transitory computer-readable storage medium further causes: executing, by one of the vehicle and the Electric Vehicle Supply Equipment (EVSE), the charging of the one or more battery packs of the vehicle in accordance with the charging schedule when the EVSE is within a predefined radius of the vehicle even though the connection to the cloud is disconnected. In an embodiment, the non-transitory computer-readable storage medium further causes: recommending the departure time, and the target battery level based on analyzing the one or more usage patterns.

The non-transitory computer-readable storage medium further causes: receiving the real-time information corresponding to the one or more factors from one of an external system and an external database.

The non-transitory computer-readable storage medium further causes: receiving the one or more inputs from a user through a user interface. In an embodiment, the non-transitory computer-readable storage medium further causes: receiving the one or more inputs through one of a personal digital assistant and a vehicle computer system.

The non-transitory computer-readable storage medium further causes: communicating data of arbitrary length of different data types to the vehicle through a communication channel. In an embodiment, the non-transitory computer-readable storage medium further causes: enabling one or more first components of the vehicle to be awake (in awake state) and receiving the data while enabling one or more second components to enter sleep mode and conserve energy.

The non-transitory computer-readable storage medium further causes: coordinating with a thermal system of the vehicle and collecting an auxiliary load consumption in different use cases. In an embodiment, the non-transitory computer-readable storage medium further causes: computing a first thermal strategy to predict a first auxiliary power to change temperature of one or more high voltage components. In another embodiment, the non-transitory computer-readable storage medium further causes: computing a second thermal strategy to predict a second auxiliary power to change the temperature of the one or more high voltage components when there is deviation in the first auxiliary power which in turn deviates from the first thermal strategy.

The non-transitory computer-readable storage medium further causes: providing a dynamic interface that determines and depicts at least one of a battery aging, a battery degradation, and a calendar battery ageing as a function of battery temperature and state-of-charge. In an embodiment, the non-transitory computer-readable storage medium further causes: computing the charging schedule to reduce a battery aging of the one or more battery packs when a connection to a cloud is lost and unable to predict the real-time information corresponding to the one or more factors.

The non-transitory computer-readable storage medium further causes: determining the one or more inputs from an itinerary of the vehicle. In one example, the non-transitory computer-readable storage medium further causes: determining the departure time and the target battery level from the itinerary of the vehicle based on one of an upcoming halt location and an upcoming destination. In another example, the non-transitory computer-readable storage medium further causes: determining the departure time, and the target battery level required to reach one of the upcoming halt locations and the upcoming destination based on charge per distance.

The non-transitory computer-readable storage medium further causes: enabling a user to set weights for the one or more user preferences through a user interface. According to this embodiment, the non-transitory computer-readable storage medium further causes: computing the charging schedule based on the weights set by the user.

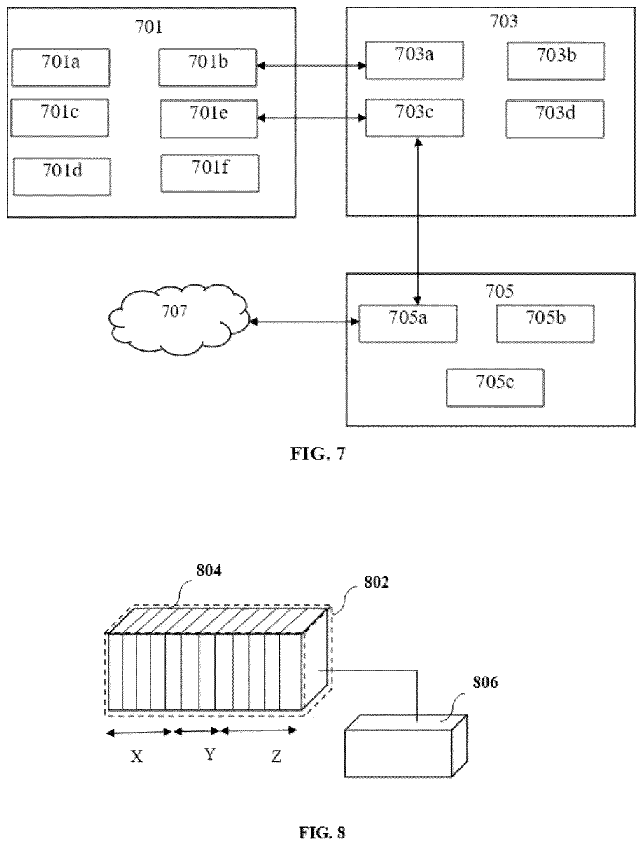

As an example, FIG. 7 illustrates an overall configuration diagram of a system according to one or more embodiments. The overall configuration diagram shows the components of each entity at a high level. Referring to FIG. 7, the system according to one or more embodiments provides a communication interface related to a charge process for an effective billing policy. To this end, the system includes entities such as an electric vehicle (EV) 701, an electric vehicle supply equipment (EVSE) 703, and a server 705. The EV 701 may be a battery-electric vehicle (BEV) or a plug-in hybrid electric vehicle (PHEV). The EV 701 is connected to a power grid 707 via the EVSE 703. Also, the EV 701 receives electric energy (or power) from the power grid 707 via the EVSE 703 (charging).

The EV 701 includes a vehicle battery 701a, an on-board charger (OBC) 701b, an electronic control unit 701c, a human-machine interface (HMI) 701d, an electric vehicle communication controller (EVCC) 701e, and a battery management system (BMS) 701f. The vehicle battery 701a is a high voltage battery installed in the EV 701 and may be referred to as a rechargeable energy storage system (RESS). The OBC 701b may be configured to include a power conversion device installed in the EV 701. The power conversion device may be a two-way charger that performs an essential function for charging the vehicle battery 701a. The OBC 701b may exchange commands and/or information related to a charging process with the EVCC 701e. The OBC 701b may be configured to further include a control chip having a data processing function (including a processor, a memory, etc.) so as to exchange the information and/or commands with the EVCC 701e. Meanwhile, FIG. 7 shows that the EVCC 701e and the OBC 701b are separated from each other, but the EVCC 701e may be consolidated into the OBC 701b. In this case, the OBC 701b may be a device configured to include the power conversion device, the control chip, and the EVCC 701e.

The electronic control unit 701c may be a unit that provides information related to the EV 701. The information related to the EV 701 may be vehicle driving-related information. The HMI 701d may have an interfacing function for displaying information related to a charging process and inputting information and/or commands related to a charging process. The input of all the information and/or commands or the display of all the information and/or commands may be performed through the HMI 701d. The HMI 701d may be configured to include a “charge button” for a vehicle user to start the charging process. The HMI 701d may be a display device having an input function for a vehicle user to input the information related to the charging process. For example, the display device may be a central information display (CID) that has a cluster informing about the velocity, mileage, battery status, and normal operation of the EV 701 and audio, video, and navigation (AVN) functions embedded therein to display and control the operation states of various devices in the EV 701. The display device displays information related to the progress of the charging process in addition to the inputs of the information related to the charging process.

The EVCC 701e may be an in-vehicle system that implements communication between the EV 701 and a supply equipment communication controller (SECC) 703c so as to support a specific function. The communication between the EVCC 701e and the SECC 703c may be, for example, a power line communication (PLC). It is assumed that the term “electric vehicle” used herein refers to an electric vehicle with a power line communication (PLC) function. The PLC may be referred to as power line carrier, mains communication, power line telecom (PLT), or power line networking (PLN). The PLC may be used as a term to describe several different systems for carrying information over power lines.

The EVCC 701e may be configured to include a memory, a processor, and a communicator. The memory includes a volatile and/or non-volatile storage medium for storing messages related to the charging process based on a protocol agreed with the SECC 703c. The processor processes messages received from the SECC 703c or processes messages to be transmitted to the SECC 703c.

The communicator may be a hardware element configured to transmit a message related to the charging process to the SECC 703c or receive a message related to the charging process from the SECC 703c on the basis of an agreed communication method, e.g., PLC. The communicator may include multiple hardware components for providing modulation, demodulation, filtering, and amplification functions.

The EVSE 703 may be a device configured to deliver energy (e.g., power, voltage, current, or the like) from the premises wiring to the EV 701 and receive energy (e.g., power, voltage, current, or the like) from the EV 701.

The EVSE 703 may be configured to include a phase(s), neutrals, protective earth conductors, EV couplers, attached plugs, accessories, power outlets, electrical outlets or appliances, and the like. The EVSE 703 may be configured to include an off-board charger 703a, an HMI 703b, an SECC 703c, and a payment unit 703d. The off-board charger 703a may be configured to include a power conversion device installed in the EVSE 703. The power conversion device in the off-board charger 703a may be a two-way charger that transfers energy to the OBC 701b installed in the EV 701 or receives energy from the OBC 701b.

From the standpoint of the off-board charger 703a, transferring energy to the OBC 701b indicates charging.

The off-board charger 703a exchanges commands and/or information related to the charging process with the SECC 703c. To this end, the off-board charger 703a may be configured to further include a control chip that processes commands and/or information transmitted to the SECC 703c or received from SECC 703c. The control chip may be configured to basically include a processor and a memory mounted on one board.

FIG. 7 shows that the off-board charger 703a and the SECC 703c are separated from each other, but the SECC 703c may be built in the off-board charger 703a. In this case, the off-board charger 703a may be configured to include the power conversion device, the control chip, and the SECC 703c. The HMI 703b has an interfacing function for displaying the commands and/or information related to the charging process and inputting the commands and/or information to the off-board charger 703a or the SECC 703c of the EVSE 703. The input of all the information and/or commands and the display of all the information and/or commands may be performed through the HMI 703b.

The HMI 703b may be configured to include a “charge button” for a vehicle user to input commands and/or information related to a charge schedule and a charging process. The HMI 703b may be a display device having an input function for a vehicle user to input commands and/or information related to a charge schedule and a charging process. The display device displays various pieces of information associated with charging progress in addition to the input function. The SECC 703c is an entity capable of communicating with one or multiple EVCCs and interacting with a secondary actor. The secondary actor is an entity that is indirectly involved in an energy transfer process including a charge process. In FIG. 7, the server 705 may be included in the secondary actor.

Further FIG. 7 shows one-to-one communication between one SECC 703c and one EVCC 701e. The present disclosure is not limited thereto, and when one SECC 703c communicates with multiple EVCCs, the SECC 703c manages the multiple EVCCs and recognizes the clusters of the outlets to which the EVCCs are connected. The SECC 703c may be configured to include a memory, a processor, and a communicator. The memory may be a volatile or non-volatile storage medium for storing messages related to the charging process on the basis of a communication protocol (communication standard) agreed with the EVCC 701e. The processor processes messages received from the EVCC 701e or processes messages to be transmitted to the EVCC 701e. The communicator may be a hardware element configured to transmit a message related to the charging process to the EVCC 701e or receive a message related to the charging process from the EVCC 701e on the basis of an agreed communication method, e.g., PLC. The communicator may include multiple hardware components for providing modulation, demodulation, filtering, and amplification functions.

The SECC 703c may communicate with the server 705. In this case, a gateway, a router, and the like may be interposed between the SECC 703c and the server 705. The SECC 703c may transmit or receive any information and/or command related to the charging process to or from the server 705. The server 705 mediates between the SECC 703c and the power grid 707. The power grid 707 includes local transformers, distribution grids, power substations, transmission grids, transmission substations, and power plants (including renewable energy).

The server 705 may be an entity for grid negotiation that provides information on the load of the grid. The server 705 collects and monitors any necessary information for any parts of the power grid 707, for example, current and expected loads of local transformers, distribution grids, power substations, transmission grids, transmission substations, and power plants. The collected current load or expected load is utilized for the EV 701 or the EVSE 703 to set up a charge schedule. In addition, the collected current load or expected load is utilized to calculate the cost (charge cost) related to the charging of an EV. For example, a sales tariff table for calculating the charging-related cost is based on the current load or expected load.

The server 705 may provide information required to set up the charge schedule in the EVCC 701e or the SECC 703c to the EVCC 701e or the SECC 703c. The collection and provision of the information performed by the server 705 may be performed by a power grid communication controller (PGCC) 705a. The PGCC 705a is configured to include a memory configured to store information collected from the power grid 707 and information collected from the EV 701 and/or the EVSE 703, a processor having a data processing function to process the collected information, and a communicator configured to transmit the processed information to the SECC 703c. An HMI 705b of the server 705 displays information collected by the server 705 and delivers information to the PGCC 705a. The HMI 705b may be a display device, and the display device has an input function. The display device displays and provides any collected information to the server 705. A control unit 705c of the server 705 manages and controls the operations of the PGCC 705a and the HMI 705b. The control unit 705c includes at least one processor having a data processing function and a computational function. The control unit 705c creates and processes a message based on a communication protocol agreed between the PGCC 705a and the SECC 703c. The server 705 may consolidate grid information collected from the power grid 707 into a grid profile and may provide the grid profile to the SECC 703c and/or the EVCC 701e.

The EV 701 and the EVSE 703 may set up the charge schedule on the basis of the grid profile provided from the server 705. Also, the server 705 may provide a proposal for the charge schedule to the SECC 703c on the basis of the grid profile. When the grid profile is changed, the server 705 may inform the SECC 703c of the necessity for an updated charge schedule (or an updated energy transfer schedule). When the server 705 is referred to as a distribution system, the server 705 may be a server responsible for voltage stability in a distribution grid.

The power grid 707 may be used as a term including a distribution system network, and the distribution system network carries electricity from a transmission grid to consumers. The distribution system network includes medium-voltage power lines, electrical substations, low-voltage distribution wiring networks, associated equipment, and the like. A communication protocol defining communication between the EVCC 701e and the SECC 703c may be the same as or different from a communication protocol defining communication between the SECC 703c and the PGCC 705a. When the communication protocols are different, the SECC 703c may convert and process commands and/or information related to the charge schedule received from the EVCC 701e using a communication protocol agreed with the PGCC 705a. Conversely, when the communication protocols are different, the SECC 703c may convert and process commands and/or information related to the charge schedule received from the PGCC 705a using a communication protocol agreed with the EVCC 701e. The communication between the EVCC 701e and the SECC 703c may be classified into a local communication connection and a remote communication connection.

As an example, FIG. 8 schematically shows a battery pack comprising a battery 802 and a battery management system 806, according to one or more embodiments. The battery 802 in turn comprises a plurality of cells 804. The battery management system 806 may include a microprocessor, microcontroller, programmable digital signal processor, or another programmable device. The battery management system 806 may also or alternatively comprise an application specific integrated circuit, a programmable gate array or programmable array logic, a programmable logic device or a digital signal processor. Where the battery management system 806 comprises a programmable device such as the microprocessor, microcontroller or programmable digital signal processor mentioned above, the processor may also comprise computer-executable code which controls the operation of the programmable device. In an embodiment, the battery management system 806 resides within an electric vehicle. The battery management system 806 determines the battery parameters (e.g., state-of-charge (SoC)) of the battery pack and communicates to the server via a communication controller.

In an embodiment, the battery management system 806 is configured to: measure a first battery property and temperature of a battery in the electric vehicle; calculating the state-of-health of the battery cell for the determined battery attributes using a predetermined modelcalc (ii) providing a function f for estimating the cell degradation rate; updating the state-of-health estimated in the previous time step according to:

$${SoH}_{est} ← {SoH}_{est} + f \cdot dt + K \cdot ( {SoH}_{{calc}^{-}} {SoH}_{est} )$$

where K is a gain factor that depends on the operating conditions of the vehicle, and where K is modified using a reinforcement learning agent for each time step.

In another embodiment, the battery management system 806 estimates state-of-health characteristics of a battery pack in a hybrid vehicle. The estimation of the SOH includes: charging and discharging the battery pack at least one time within an upper region of a State-of-charge (SOC) window. In this case, the battery pack is charged to a first predetermined level in the upper region of the SOC window during the first time period. A first charge current impulse then discharges the battery pack for pushing the SOC level of the battery pack to a level above the first predetermined level and outside the SOC window, during a second time period. An electrical machine then discharges the battery pack to a second predetermined level within the SOC window.

The estimation of the SOH further includes: charging and discharging the battery pack at least one time within a lower region of the SOC window. In this case, the battery pack is charged to a third predetermined level in the SOC window, during a third time period. An electrical machine then discharges the battery pack to a fourth predetermined level in the SOC window. A second current impulse then discharges the battery pack for pushing the SOC level of the battery pack to a level below the fourth predetermined level and below the SOC window, during a fourth time period.

The estimation of the SOH further includes: calibrating by the battery management system 806 comprised in the vehicle by using the reached levels outside the SOC window for determining correct upper and lower edges of the current SOC window; and estimating the SOH characteristics of the battery pack during the charge and discharge periods by using the battery management system 806 for determining the condition of the battery pack in comparison to a new and unused battery pack by comparing the current SOC window with a standard SOC window. In an embodiment, the first and third time period is longer than the second and fourth time period, respectively. In another embodiment, the first predetermined level represents a higher voltage, than the second predetermined level and the third predetermined level represents a higher voltage, than the fourth predetermined level.

The battery management system 806 measures voltage, current, temperature, charge cycles, and capacity of the battery 802. The battery management system 806 logs these parameters in real-time. In an example, the parameters measured comprise inputs as follows: Current Capacity: 45 Ah (measured); Nominal Capacity: 50 Ah (original); and Age: 3 years. The battery management system 806 calculates the state-of-health (SoH) as SOH=(Nominal Capacity/Current Capacity)×100. According to the above example, SoH=(45/50)*100=90%. The battery management system 806 uses the past SoH values to determine the capacity degradation rate. Degradation rate is calculated using the following equation. Degradation rate=(100%-SoH)/age. According to the above example, Degradation rate=(100-90)/3=3.3% per year. The battery management system 806 then calculates “Remaining life”=(SoH-80%)/Degradation rate. According to the above example, Remaining life=(90-80)/3.3=3 years remaining. The battery management system 806 with its dynamic interface displays the (user interface) UI elements such as SoH; Estimated Remaining life; and Warning. According to the above example, the battery management system 806 displays the (user interface) UI elements as SoH: 90%; Estimated Remaining life: 3 years; and Warning: Consider battery replacement after 2 years.

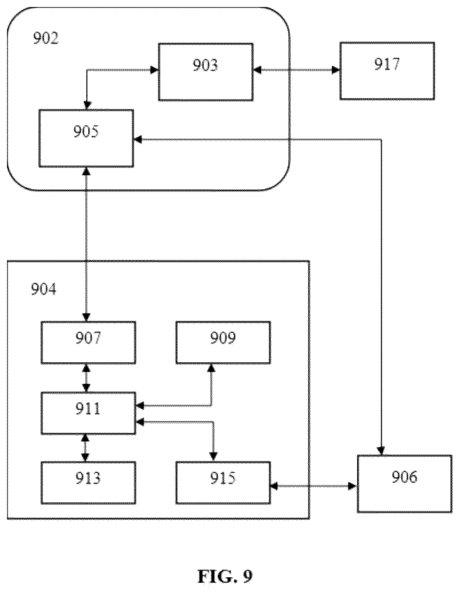

As an example, FIG. 9 illustrates an overall system architecture, according to one or more embodiments. The overall system architecture comprises a server 902, an electric vehicle (EV) 904, and an electric vehicle supply equipment (EVSE) 906. The server 902 resides in a cloud. In one embodiment, the server 902 resides within the EV 904. In another embodiment, the server 902 resides within the EVSE 906.

This architecture not only provides a great flexibility when sending and executing a charging start/stop request, but also supports receiving real-time information from multiple sources during a charging session. For example, when a user does not have a paired EVSE installed at a charging location, or the paired EVSE has internet connection issues, the optimized charging schedule can be set directly to the EV for execution. On the other hand, for a customer who has a paired EVSE, the optimized charging schedule can be set directly to the EVSE for execution, which has faster data transfer rate to the cloud, and quicker execution of start/stop charging requests. Furthermore, by considering both the EVSE and the EV, the system may optimize the operation of individual components in the EV or the EVSE (e.g., charging power, battery temperature) to achieve a higher charging efficiency for the overall system (from EVSE to battery).

Rather than computing a charging schedule by only considering either an EV or a EVSE separately, this system computes using both an EV and a paired EVSE. By considering both entities concurrently, the overall system efficiency and resilience is improved. For example, to reduce the user's overall operating cost, an optimized charging schedule is computed such that a balanced reduction in electricity cost and battery aging cost can be achieved, while fulfilling power constraints at the EVSE. The system may also be more resilient to the loss of internet connection, as the charging schedule can be executed in either the EV or EVSE. The system is configured to take into account the constraints (e.g., battery parameters, state-of-health of the battery, battery temperature, battery aging, etc.) from the EV side and the constraints (e.g., grid parameters, ambient temperature, external temperature, charging cost, peak demand hours, off-demand hours, energy-mix CO₂, environmental factors etc.) from the EVSE side. The system is configured to consider the constraints from the EV side and the constraints from the EVSE side and compute the optimized charging schedule such that it enhances efficiency of the vehicle as well as efficiency of the power grid.

The server 902 comprises a vehicle database unit 903 and an energy management unit 905. The vehicle database unit 903 collects and records information related to the EV 904. The vehicle database unit 903 records the information such as the itinerary of the user of the vehicle. The vehicle database unit 903 further comprises usage patterns, departure times, battery specification, vehicle state, etc. The vehicle database unit 903 records activities executed by the vehicle. The energy management unit 905 is configured to compute the charging schedule.

The EV 904 comprises a telematics module 907, a display 909, a vehicle energy management unit 911, a battery management system 913, and a charging controller 915. The display 909 is adapted to receive the one or more settings from the user. The display 909 may be a display on the dashboard. The display 909 is configured to display an interactive menu which enables the user to drag and select the settings. The server 902 may also receive settings/inputs from the user via the mobile application 917 on a user device. The user device may be an external device such as a personal digital assistant. The personal digital assistant may be one of a smartphone, a tablet, a computer, a smartwatch, a desktop, etc. The telematics module 907 is configured to change the settings/inputs either through the mobile application 917 or the display 909. The telematics module 907 is configured to synchronize the settings/inputs through either the mobile application 917 or the display 909 with each other. The server 902 enables the user to configure the settings/inputs. The settings/inputs may comprise at least one of smart charging ON/smart charging OFF, departure time on selected weekdays, charging location, target battery level at departure, and minimum battery level.

The battery management system 913 is configured to analyze and determine the one or more battery parameters of the one or more battery packs within the EV 904. The battery management system 913 further determines the one or more battery parameters using one or more sensors associated with the EV 904.

The energy management unit 905 and the vehicle energy management unit 911 are responsible for the computation and coordination of the optimized charging schedule. The energy management unit 905 and the vehicle energy management unit 911 computes the charging schedule such that some desired criteria are optimized, such as minimizing energy cost, energy-mix CO₂, battery aging or a combination of these factors, while considering customers' needs, usage pattern and environmental factors. The charging controller 915 executes charging sequences in accordance with the charging schedule. The charging controller 915 communicates with the EVSE 906 to execute the charging. The charging controller 915 may comprise an on-board charger and a communication controller. The on-board charger is configured to receive power from the EVSE 906 and execute the charging sequence in accordance with the charging schedule. The communication controller is configured to communicate with the server 902 and the EVSE 906.

The energy management unit 905 and the vehicle energy management unit 911 communicate with each other using a multiplexing signal protocol. The multiplexing signal protocol is configured to communicate data of arbitrary length from the energy management unit 905 to the vehicle energy management unit 911. The multiplexing signal protocol is configured to send different types of data, such as electricity price (price vs time) and/or charging strategy (power vs time) over the same communication channel/signal. Since the multiplexing signal protocol enables transmission of data of arbitrary length when the vehicle is awake, this allows some components (e.g., telematics module 907, display 909, etc.) to enter “sleep” mode to conserve energy, while only keeping some components alive (e.g. vehicle energy management unit 911, battery management system 913, and charging controller 915) during the charging.

The EVSE 906 comprises an off-board charger and a communication controller (not shown). The communication controller may receive the charging schedule from the server 902 or the vehicle energy management unit 911 of the EV 904. The EVSE 906 then provides instructions to the off-board charger to provide requisite power to the on-board charger of the EV 904 in accordance with the charging schedule. The on-board charger of the EV 904 receives the power from the off-board charger and charges the one or more battery packs of the EV 904 to the target battery level within the departure time in accordance with the charging schedule.

Use case 1: The use case discusses the scenario when an EV 904 has lost internet connection (hence does not have connection to the Cloud, and no access to the electricity price). When the EV 904 arrives at a set charging location (with Smart Charging enabled), the vehicle energy management unit 911 computes the charging schedule so that the effect on battery aging during charging is reduced. The battery pack may have different battery chemistry. Considering the different battery chemistry, the vehicle energy management unit 911 is dependent on a dynamic interface provided by the battery management system 913 to compute the charging schedule. The dynamic interface provides calendar battery ageing and cycling aging cost as a function of temperature and SoC.

With the provided energy to fully discharge and energy to fully charge from the battery management system 913, the vehicle energy management unit 911 is capable of mapping the battery aging cost table from SoC to battery energy to fully discharge. The vehicle energy management unit 911 performs thermal/cooling planning to achieve the expected charging power. Based on the thermal/cooling planning done, the vehicle energy management unit 911 predicts the temperature of the battery as a function of time. Specifically, the vehicle energy management unit 911 coordinates with the thermal system of the EV and collects the auxiliary power consumption in different use cases. This enables the vehicle energy management unit 911 to estimate and predict the needed auxiliary power to heat/cool the HV (High voltage) system, including the battery management system 913 and the vehicle energy management unit 911, to achieve the expected power. Hence, the vehicle energy management unit 911 itself has the necessary info to utilize the battery aging cost table to find an optimized charging schedule to reduce battery aging. The vehicle energy management unit 911 sets the heat/cooling strategy.

In an embodiment, the vehicle energy management unit 911 detects deviation or a significant change of the auxiliary consumption from the predicted heat/cooling strategy. When there is significant deviation, the vehicle energy management unit 911 wakes up to set a new thermal strategy resulting in a new prediction of auxiliary power consumption. In worst case, if the vehicle energy management unit 911 cannot coordinate with the thermal system to heat/cool the EV system, the vehicle energy management unit 911 is configured to predict the available battery charging/discharging power as function of time based on the charging/discharging power table as a function of temperature and SoC. With such design, the system is configured to adapt to the latest capability of the EV. The system takes account of the predicted battery charging/discharging power and auxiliary power consumption while computing the charging schedule.

Use Case 2: This use case discusses the scenario when the energy management unit 905 in the server 902 computes an optimized charging schedule by considering external and/or market data. When Smart Charging is enabled (either from the display 909 or mobile application 917), the energy management unit 905 is notified about the settings. The energy management unit 905 computes an optimized charging schedule when the vehicle is at the set charging location. The energy management unit 905 computes the optimized charging schedule based on electricity price, CO₂ emission of the energy-mix, etc. The energy management unit 905 via the user interface displays an interactive user interface and enables the user to set a weight for each of the factors. The energy management unit 905 computes the charging sequence using a cost equation. The cost equation has fields that enable the user to set a weight for each of the factors. The cost equation is used to arbitrate the electricity price, CO₂ emission cost of the energy-mix and battery aging cost. The energy management unit 905 provides the customer the flexibility to set weights for them, respectively. The energy management unit 905 performs the charging schedule calculation. The energy management unit 905 then sends the charging schedule to the vehicle energy management unit 911 of the EV through telematics module 907. If a schedule from the energy management unit 905 is available, then the schedule is prioritized by the vehicle energy management unit 911 to control the charging session over the schedule calculated in Use Case 1. Below is an example of the cost equation,

$${Cost}_{equivalant} = {a}_{1} * {Cost}_{electricity} + {a}_{2} * {Cost}_{CO 2} + {a}_{3} * {Cost}_{BattAging}$$

The server 902 provides priority of use case 2 over use case 1, as the use case 2 is capable of considering external and/or market data and calculates the charging schedule in accordance with the real-time data. The use case 2 provides a more efficient and reliable charging schedule as the fluctuation of electricity cost is monitored from time to time based on the external and/or market data.

Use Case 3: Use case 3 discusses the scenario when an EV has lost internet connection when arriving at a Smart Charging location. However, prior to the loss of connection, a pre-computed charging schedule had been computed at the energy management unit 905 in the server 902 in the cloud and sent to the vehicle energy management unit 911 and the charging controller 915. Upon arriving at the charging location, the charging controller 915 executes the optimized charging schedule without the need of connection to the server 902 in the cloud. This approach has a high dependency on the radius of the saved location, if the radius of the saved location is too big, then the calculation of the optimized schedule has higher risk of not complying with the customer setting, because the vehicle state reflected in the vehicle database unit 903 probably has more deviation compared with the reality.

Use Case 4: The use case 4 discusses the scenario, when the EVSE 906 is a paired unit that has telematics communication capability. According to this scenario, the EVSE 906 is integrated into the holistic charging system. Therefore, the energy management unit 905 in the server 902 can send the optimized charging schedule to the EVSE 906 via certain protocols. Moreover, the energy management unit 905 also acts as a decision maker for a cluster of EV 904 and EVSE 906, hence ensuring that there is only one entity (either EV 904 or EVSE 906) that is responsible for the execution of the optimized charging schedule. Specifically, the EVSE 906 sends a unique EVSE ID to the energy management unit 905 in the cloud. At the same time, the EVSE 906 sends the EVSE ID to EV 904. EV 904 sends the EVSE ID, together with the VIN (vehicle identification number), to the energy management unit 905 in the cloud. The energy management unit 905 in the cloud is then capable of validating the pairing of EV 904 or EVSE 906. This use case is beneficial in the scenario that the wake-up timing of EV 904 is too long to meet certain fast response requirements, for example VPP (Virtual Power Plant).

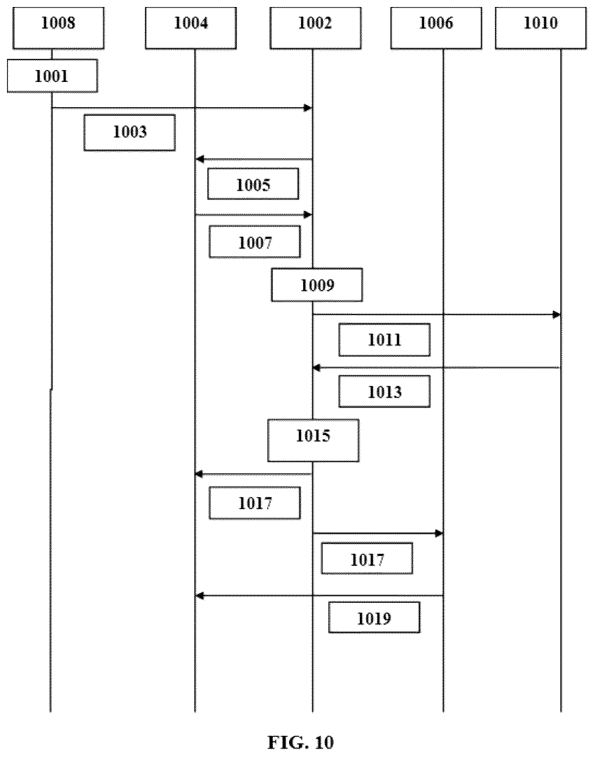

As an example, FIG. 10 illustrates a communication flow between a server 1002, an electric vehicle (EV) 1004, and an electric vehicle supply equipment (EVSE) 1006, according to one or more embodiments. The server 1002 resides in the cloud and is communicatively coupled to the EV 1004 and the EVSE 1006. At step 1001, the user provides the one or more inputs via the input device 1008 (e.g., vehicle computer system, personal digital assistant). The user may configure the one or more settings via the input device. At step 1003, the server 1002 receives the one or more inputs related to a charging schedule. The one or more inputs comprises a departure time, a target battery level, and one or more user preferences. The server 1002 may extract the one or more inputs from an external system. For example, the server 1002 may extract the one or more inputs (e.g., the departure time, the target battery level, and the one or more user preferences) from an itinerary of the user of the vehicle.

At step 1005, the server 1002 communicates a command to the EV 1004 to receive information that impacts the charging schedule. The battery management system within the EV 1004 may send at least one of the battery specification, battery parameters, (e.g., state-of-health, state-of-charge, etc.) based on the inputs to the server 1002. At step 1007, the server 1002 receives the information from the EV 1004.

At step 1009, the server 1002 analyzes the information and determines the one or more factors that influence the charging schedule in accordance with the one or more inputs. In an example, the server 1002 may determine the state-of-health as the factor that influences the charging schedule when the departure time is actually less than the usual/unexpected time and the rate of charging is slow. In another example, the server 1002 may determine the charging cost as the factor that influences the charging schedule when the departure time is actually less than the usual/expected time. The server 1002 comprises an artificial intelligence engine that determines the charging duration based on the one or more inputs. The server 1002 determines the charging duration as 3 PM to 5 PM when the departure time is 5.10 PM. Based on the charging duration, the server 1002 using the artificial intelligence engine predicts the real-time information (i.e., real-time charging cost) for that charging duration. In this case, the server 1002 computes or modifies the charging schedule (e.g., 1 hour in advance) such that charging cost does not impact the charging of the battery packs to the target battery level within the departure time.

At step 1011, the server 1002 communicates a command to an external system 1010 (e.g., external database) to receive the real-time information. At step 1013, the server 1002 receives a response (e.g., charging cost tariffs, peak demand hours, etc.) from the external system. At step 1015, the server 1002 predicts the real-time information (e.g., real-time charging cost for that instant time) as illustrated above in the example. At step 1015, the server 1002 computes the charging schedule in accordance with the real-time information to charge one or more battery packs of a vehicle to the target battery level within the departure time of the vehicle. At step 1017, the server 1002 communicates the charging schedule to the EV 1004 and the EVSE 1006. At step 1019, the EVSE 1006 delivers power to the vehicle via the off-board charger in accordance with the charging schedule to charge the battery packs of the vehicle using the on-board charger.

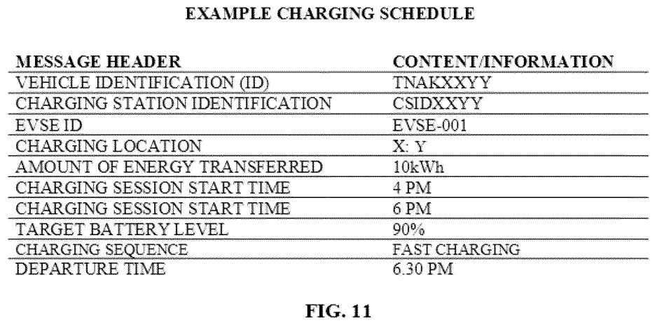

As an example, FIG. 11 illustrates a charging schedule computed by the processor, according to one or more embodiments. The processor computes the charging schedule in accordance with the real-time information to charge one or more battery packs of a vehicle to the target battery level within the departure time of the vehicle. The charging schedule comprises fields such as a vehicle identification number, a charging station identification number, an electric vehicle supply equipment identification number (EVSE ID), a charging location, a charging session start time, a charging session end time, a target battery level, a departure time, and a charging sequence.

The vehicle identification number field comprises vehicle identification number (for example, TX1234AB). The vehicle identification number is used to identify and recognize the identity of the EV for which the charging is to be done. The charging station identification number field comprises vehicle identification number (for example, CSIDXXYY). The charging station identification number is used to identify and recognize the identity of the charging station. The EVSE ID field comprises EVSE identification number (for example, EVSE-001). The EVSE station identification number is used to identify and recognize the EVSE among the multiple EVSEs within the charging station. The charging location comprises the exact location information where the vehicle is to be charged at the scheduled time.

The charging session start time field comprises timing information from which the charging session is to be started. The charging session end time field comprises timing information up to which the charging is to be done. The target battery level field comprises the charging status information up to which the charging is to be done. The departure time field comprises timing information when the vehicle would depart from the charging location. The departure time may be computed based on itinerary information of the user of the vehicle. The charging sequence field comprises information of a predefined charging strategy to charge the one or more battery packs of the EV to the target battery level within the departure time. The charging sequence comprises one of a regular charging, a fast charging, and a trickle charging.

In an embodiment of the system, the artificial intelligence engine comprises a machine learning model. The machine learning model is configured to learn using labeled data using a supervised learning method, wherein the supervised learning method comprises logic using at least one of a decision tree, a logistic regression, a support vector machine, a k-nearest neighbors, a Naïve Bayes, a random forest, a linear regression, a polynomial regression, and a support vector machine for regression.

In an embodiment of the system, the machine learning model is configured to learn from the real-time data using an unsupervised learning method, wherein the unsupervised learning method comprises logic using at least one of a k-means clustering, a hierarchical clustering, a hidden Markov model, and an a priori algorithm.

In an embodiment of the system, the machine learning model has a feedback loop, wherein the output from a previous step is fed back to the model in real-time to improve the performance and accuracy of the output of a next step.

In an embodiment of the system, the machine learning model comprises a recurrent neural network model.

In an embodiment of the system, the machine learning model has a feedback loop, wherein the learning is further reinforced with a reward for each true positive of the output of the system.

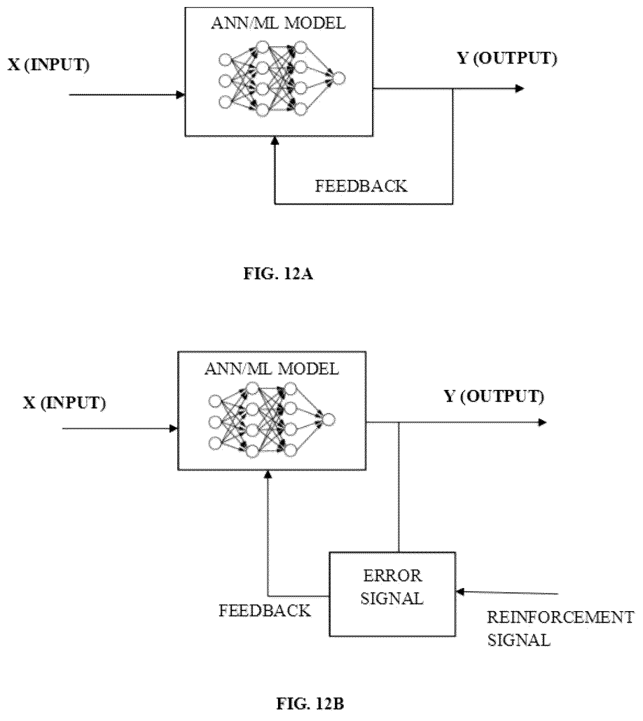

FIG. 12A shows a structure of the neural network/machine learning model with a feedback loop. Artificial neural networks (ANNs) model comprises an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed to the next layer of the network. A machine learning model or an ANN model may be trained on a set of data to take a request in the form of input data, make a prediction on that input data, and then provide a response. The model may learn from the data. Learning can be supervised learning and/or unsupervised learning and may be based on different scenarios and with different datasets. Supervised learning comprises logic using at least one of a decision tree, logistic regression, and support vector machines. Unsupervised learning comprises logic using at least one of a k-means clustering, a hierarchical clustering, a hidden Markov model, and an a priori algorithm. The output layer may predict or detect the target battery level and the charging schedule based on the input data.

In an embodiment, ANNs may be a Deep-Neural Network (DNN), which is a multilayer tandem neural network comprising Artificial Neural Networks (ANN), Convolution Neural Networks (CNN) and Recurrent Neural Networks (RNN) that can recognize features from inputs, do an expert review, and perform actions that require predictions, creative thinking, and analytics. In an embodiment, ANNs may be Recurrent Neural Network (RNN), which is a type of Artificial Neural Networks (ANN), which uses sequential data or time series data. Deep learning algorithms are commonly used for ordinal or temporal problems, such as language translation, Natural Language Processing (NLP), speech recognition, and image recognition, etc. Like feedforward and convolutional neural networks (CNNs), recurrent neural networks utilize training data to learn. They are distinguished by their “memory” as they take information from prior input via a feedback loop to influence the current input and output. An output from the output layer in a neural network model is fed back to the model through the feedback. The variations of weights in the hidden layer(s) will be adjusted to fit the expected outputs better while training the model. This will allow the model to provide results with far fewer mistakes.

The neural network is featured with the feedback loop to adjust the system output dynamically as it learns from the new data. In machine learning, backpropagation and feedback loops are used to train an AI model and continuously improve it upon usage. As the incoming data that the model receives increases, there are more opportunities for the model to learn from the data. The feedback loops, or backpropagation algorithms, identify inconsistencies and feed the corrected information back into the model as an input.

Even though the AI/ML model is trained well, with large sets of labeled data and concepts, after a while, the models' performance may decline while adding new, unlabeled input due to many reasons which include, but not limited to, concept drift, recall precision degradation due to drifting away from true positives, and data drift over time. A feedback loop to the model keeps the AI results accurate and ensures that the model maintains its performance and improvement, even when new unlabeled data is assimilated. A feedback loop refers to the process by which an AI model's predicted output is reused to train new versions of the model.

Initially, when the AI/ML model is trained, a few labeled samples comprising both positive and negative examples of the concepts (for e.g., usage patterns) are used that are meant for the model to learn. Afterward, the model is tested using unlabeled data. By using, for example, deep learning and neural networks, the model can then make predictions on whether the desired concept/s (e.g., compute charging schedules) are in unlabeled data. Each content is given a probability score where higher scores represent a higher level of confidence in the models' predictions. Where a model gives the data a high probability score, it is auto labeled with the predicted concept. However, in the cases where the model returns a low probability score, this input may be sent to a controller (may be a human moderator) which verifies and, as necessary, corrects the result. The human moderator may be used only in exception cases. The feedback loop feeds labeled data, auto-labeled or controller-verified, back to the model dynamically and is used as training data so that the system can improve its predictions in real-time and dynamically.

FIG. 12B shows a structure of the neural network/machine learning model with reinforcement learning. The network receives feedback from authorized networked environments. Though the system is similar to supervised learning, the feedback obtained in this case is evaluative not instructive, which means there is no teacher as in supervised learning. After receiving the feedback, the network performs adjustments of the weights to get better predictions in the future. Machine learning techniques, like deep learning, allow models to take labeled training data and learn to recognize those concepts in subsequent data. The model may be fed with new data for testing, hence by feeding the model with data it has already predicted over, the training gets reinforced. If the machine learning model has a feedback loop, the learning is further reinforced with a reward for each true positive of the output of the system. Feedback loops ensure that AI results do not stagnate. By incorporating a feedback loop, the model output keeps improving dynamically and over usage/time.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings, such terms are intended to be inclusive in a manner similar to the term “comprising,” as “comprising” is interpreted when employed as a transitional word in a claim.

Other specific forms may embody the present disclosure without departing from its spirit or characteristics. The embodiments described are in all respects illustrative and not restrictive. Therefore, the appended claims, rather than the description herein, indicate the scope of the disclosure. All variations which come within the meaning and range of equivalency of the claims are within their scope.

1-90. (canceled)

91. A system comprising:
a server that comprises
a non-transitory memory; and
a processor storing instructions in the non-transitory memory that, when executed, causes the processor to:
receive one or more inputs related to a charging schedule, wherein the one or more inputs comprises a departure time, a target battery level, and one or more user preferences;
determine one or more factors that influence the charging schedule in accordance with the one or more inputs, wherein the one or more factors comprises at least one of a charging time, a charging duration, an itinerary, a charging cost, one or more battery parameters, one or more grid parameters, one or more usage patterns, and one or more external conditions;
predict real-time information corresponding to the one or more factors;
compute the charging schedule in accordance with the real-time information to charge one or more battery packs of a vehicle to the target battery level within the departure time of the vehicle; and
communicate the charging schedule to at least one of an on-board charger of the vehicle and an Electric Vehicle Supply Equipment (EVSE).

92. The system of claim 91, wherein the system is communicatively coupled to a battery management system of the vehicle.

93. The system of claim 92, wherein the battery management system analyses the one or more battery packs of the vehicle and determines the one or more battery parameters, the one or more grid parameters, the one or more usage patterns, and the one or more external conditions.

94. The system of claim 91, wherein the one or more factors comprises at least one of the charging time, the charging duration, the itinerary, the charging cost, a state-of-health, a state-of-charge, a battery temperature, a charging temperature, and an ambient temperature.

95. The system of claim 91, wherein the processor is operable to receive the real-time information corresponding to the one or more factors from one of an external system and an external database.

96. The system of claim 91, wherein the system resides in a cloud.

97. The system of claim 91, wherein the system resides in one of the vehicle and the Electric Vehicle Supply Equipment (EVSE).

98. The system of claim 96, wherein the processor is operable to
communicate a first command to the Electric Vehicle Supply Equipment (EVSE) to send an Electric Vehicle Supply Equipment Identification (EVSE ID) to the vehicle and the processor; and
communicate a second command to the vehicle to validate the Electric Vehicle Supply Equipment Identification (EVSE ID) and pair the vehicle and the Electric Vehicle Supply Equipment (EVSE) in the cloud.

99. The system of claim 98, wherein the on-board charger receives power from the Electric Vehicle Supply Equipment (EVSE) and charges the one or more battery packs of the vehicle in accordance with the charging schedule.

100. The system of claim 99, wherein one of the vehicle and the Electric Vehicle Supply Equipment (EVSE) executes charging of the one or more battery packs of the vehicle in accordance with the charging schedule when the EVSE is within a predefined radius of the vehicle though a connection to the cloud is disconnected.

101. The system of claim 91, wherein the processor is operable to communicate data of arbitrary length of different data types to the vehicle through a communication channel.

102. The system of claim 101, wherein the processor is operable to enable one or more first components of the vehicle to be awake and receive the data while enabling one or more second components to enter sleep mode and conserve energy.

103. A method comprising:
receiving, by a processor, one or more inputs related to a charging schedule, wherein the one or more inputs comprises a departure time, a target battery level, and one or more user preferences;
determining, by the processor, one or more factors that influences the charging schedule in accordance with the one or more inputs, wherein the one or more factors comprises at least one of a charging time, a charging duration, an itinerary, a charging cost, one or more battery parameters, one or more grid parameters, one or more usage patterns, and one or more external conditions;
predicting, by the processor, real-time information corresponding to the one or more factors;
computing, by the processor, the charging schedule in accordance with the real-time information to charge one or more battery packs of a vehicle to the target battery level within the departure time of the vehicle; and
communicating, by the processor, the charging schedule to at least one of an on-board charger of the vehicle and an Electric Vehicle Supply Equipment (EVSE).

104. The method of claim 103, further comprising: analysing, by a battery management system, the one or more battery packs of the vehicle and determining the one or more battery parameters, the one or more grid parameters, the one or more usage patterns, and the one or more external conditions; and providing, by the battery management system, a dynamic interface that determines and depicts at least one of a battery aging, a battery degradation, and a battery calendar as a function of battery temperature and state-of-charge.

105. The method of claim 104, further comprising: coordinating, by the battery management system, with a thermal system of the vehicle and collects an auxiliary load consumption in different use cases.

106. The method of claim 105, further comprising: computing, by the battery management system, a first thermal strategy to predict a first auxiliary power to change temperature of one or more high voltage components.

107. The method of claim 106, further comprising: computing, by the battery management system, a second thermal strategy to predict a second auxiliary power to change the temperature of the one or more high voltage components when there is deviation in the first auxiliary power which in turn deviates from the first thermal strategy.

108. A non-transitory computer-readable storage medium storing a sequence of instructions in a memory, which when executed by a processor, causes:
receiving one or more inputs related to a charging schedule, wherein the one or more inputs comprises a departure time, a target battery level, and one or more user preferences;
determining one or more factors that influences the charging schedule in accordance with the one or more inputs, wherein the one or more factors comprises at least one of a charging time, a charging duration, an itinerary, a charging cost, one or more battery parameters, one or more grid parameters, one or more usage patterns, and one or more external conditions;
predicting real-time information corresponding to the one or more factors;
computing the charging schedule in accordance with the real-time information to charge one or more battery packs of a vehicle to the target battery level within the departure time of the vehicle; and
communicating the charging schedule to at least one of an on-board charger of the vehicle and an Electric Vehicle Supply Equipment (EVSE).

109. The non-transitory computer-readable storage medium of claim 108, further causes: enabling a user to set weight for the one or more user preferences through a user interface.

110. The non-transitory computer-readable storage medium of claim 109, further causes: computing the charging schedule based on the weight set by the user.
